(19) United States
(12) Patent Application Publication
(10) Pub. No.: US 2024/0257692 A1
(43) Pub. Date: Aug. 1, 2024

(54) METHOD AND SYSTEM FOR COMPUTER-BASED IMAGE AND DISPLAY

(71) Applicant: Meta Platforms Technologies, LLC, Menlo Park, CA (US)

(72) Inventor: Edward Buckley, High Peak (GB)

(21) Appl. No.: 18/491,666

(22) Filed: Oct. 20, 2023

(51) Int. Cl. G09G 3/20

(52) U.S. Cl. CPC G09G 3/2011; G09G 2320/0633

(57) ABSTRACT

In one embodiment, an electronic device having a phase-modulating display module and an amplitude-modulating display module may determine a pattern comprising a number of zones. The pattern may correspond to display areas that contain imagery content to be displayed. Each zone may correspond to a number of pixels of the amplitude-modulating display module. The device may steer, by the phase-modulating display module, incident light beams from a first light source to the display areas of the amplitude-modulating display module according to the pattern. The device may modulate, by the amplitude-modulating display module, a light intensity amplitude of a light beam at a pixel location according to a target grayscale value for a display pixel at that pixel location. The device may cause the light beam having the modulated light intensity amplitude to reach a viewer's eye.

### TECHNICAL FIELD

This disclosure generally relates to computer image technologies, such artificial reality.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Embodiments described herein address the foregoing problems by providing a hybrid system where a resource-constrained device (e.g., AR/VR/MR client system) that needs to send or share a video is only tasked with performing very lightweight compute (e.g., bicubic down-sampling) and/or video compression using existing power-efficient video codecs (e.g. H.1264/H.1265). The result would be a low-resolution, artifact-ridden video at low bitrate for transmission to a cloud server or companion phone device (which may be referred to as a “stage”). The receiving device (server or companion phone device), having relatively more computational and power resources, may then use an AI/ML-based image enhancer to perform super-resolution upscaling and compression artifact removal. This approach achieves high-quality AI/ML-based videos despite the source device having limited resources.

Particular embodiments described herein relate to a display that uses a phase-modulating display module (liquid-crystal display) as a light source to provide zonal backlight for an amplitude-modulating display module to display AR images. An amplitude-modulating display module display may have an even light source which provides even backlights for all pixels. The light emitted by the light source may be polarized in two directions of S and P. The polarized light may be projected to a split lens which is positioned at 45-degree angle to the light source plane. The split lens may allow the light polarized in the P direction to pass (and thus cause this portion of light to be wasted), but may reflect the light polarized in the S direction to the amplitude-modulating display module plane. Each pixel of the amplitude-modulating display module may be controlled to be “turned on” to allow at least some light to pass and reflected or “turned off” to absorb the incident light. If the pixel is “turned off”, all the incident light at that pixel location may be absorbed and no light may be reflected to the user's eye. When a pixel is “turned on,” the LCD pixel at that location may be controlled to allow at least a portion of the light to pass. The liquid crystal at that location may be controlled to absorb the incident light (and thus reduce the light intensity amplitude) at that pixel location according to the target grayscale value for that pixel. As such, the light that passes through the liquid crystal at that pixel location may have been attenuated by the amplitude-modulating display module in a per pixel manner according to the target grayscale value of that pixel. The light beams that are reflected by the amplitude-modulating display module may be reflected by a back panel which serves as a ¼ wavelength plate for phase shifting and reflects the incident light along the opposite of the incident direction with a phase shift. The incident light polarized in the S direction may be shifted in phase and polarized in the P direction after being reflected. When the reflected light beams polarized in the P direction hit the split lens, the spit lens may allow the light beams to pass through it to reach the viewer's eye.

To display a color image, the light source may emit light in RGB colors sequentially in time and the amplitude-modulating display may control its pixels to reflect/absorb the incident light of different color channel sequentially in time to display the image. The backlight source may evenly light up all the pixels of the display panel. For the areas that have no imagery content, the backlight may be blocked (e.g., absorbed) by the LCD and thus become wasted. Because of the sparse nature of AR imagery, a large portion of the backlight power may be wasted. Furthermore, because of the light of each color channel is attenuated to achieve the target grayscale and the light is split by the split lens, the overall brightness of the displayed image on the LCD display may be very limited. As such, the amplitude-modulating display module may be inefficient in power consumption. To achieve sufficient brightness, the light source for the backlight may need to use more power to provide higher light intensities.

In particular embodiments, to solve the above problems, the light source for the even backlight of the amplitude-modulating display module may be replaced by a phase-modulating display module. The phase-modulating display module may serve as a 2D zonal backlight source with steerable backlight for the amplitude-modulating display module. The phase-modulating display module may have a laser light source as its own backlight source, which can have low-power consumption and can be very efficient. The phase-modulating display module may modulate the phase front of the incident light and steer the light beams along any directions to target pixel areas. In other words, the phase-modulating display module may arbitrarily steer the incident light beams to any directions as needed. As such, the display system may use the phase-modulating display module to steer the light beams from the laser light source to the amplitude-modulating display module's pixel areas that have imagery content. As a result, the light from the laser light source of the phase-modulating display module may be focused on the pixel areas that have imagery content (rather than having a large portion being wasted as in the traditional amplitude-modulating display module). In other words, the light beams that are originally directed to (i.e., without steering) the pixel areas having no imagery content may be steered to the pixel areas that have imager content, rather than being wasted as in the amplitude-modulating display module with non-steerable light source. Using this approach, the AR display system may achieve high power efficiency (with less wasted light) and higher brightness (e.g., light concentrated to the image content areas), despite the sparse nature of AR imagery.

To display an AR image, the display system may first determine a pattern corresponding to pixel areas that contain the AR imagery content. The pattern may include a number of zones where each zone may include an array of display pixels of the amplitude-modulating display module, corresponding to a block of pixel area of the amplitude-modulating display module. The display system may use a pre-determined zone size which is optimized to maximum the efficient and brightness of the display. Then, the phase-modulating display module may steer the light beams from the laser light source to these zones according to the pattern, rather than lighting up the whole display panel evenly like the traditional LCD. In other words, the phase-modulating display module may steer the light beams that originally would be directed to the pixel areas having no imagery content to the pixels areas that have imagery content. The lighted pattern may serve as the backlight for the amplitude-modulating display module. The backlight provided by the lighted pattern generated by the phase-modulating display module may be polarized in the S direction and may be projected to the split lens. The split lens may reflect these light beams polarized in the S direction to the pixel plane of the amplitude-modulating display module to provide backlight for the pixels of the amplitude-modulating display module according to the pattern including a number of zones.

The laser source of the phase-modulating display module may emit light with a particular color of the RGB colors. As described above, the phase-modulating display module may steer the light beams emitted by the laser source in the particular color to the split lens, which may reflect these light beams to the pixel plane of the amplitude-modulating display module according to the pattern including the corresponding zones. The lighted pattern which includes a number of zones may serve as the light source the backlight of the amplitude-modulating display module. The display pixels in each zone may be lighted to a same base target color, which may correspond to an average pixel color of that particular color channel of the image pixels corresponding to that zone area. The amplitude-modulating display module may control its display pixels to attenuate/absorb the incident light according to the corresponding target pixel values, and reflect the light back to the split lens. In other words, the amplitude of the light intensity may be modulated in a per pixel manner to achieve the target grayscale values. The light that is reflected by the amplitude-modulating display module may be projected to the split lens and may be polarized in the P direction. As a result, the reflected light may pass through the split lens to reach the viewer's eye.

The laser source may emit light in RGB colors sequentially in time. For each zone of the pattern to be lighted up, the display system may determine a target base color for each color channel, which could be the average target pixel color for the display pixels in that zone (per color channel), and the zone may be lighted to that target base color for that color channel. Then, the backlight of these zones may be attenuated/modulated by the amplitude-modulating display module in a per pixel manner to according to the corresponding target grayscale values to display the image. The display system may work sequentially in time to display three images corresponding to the RGB color channel, sequentially in time, which will cause the human eyes to perceive as a whole picture. As a result, the AR image may be displayed with a greater brightness while the display system consumes much less power.

Particular embodiments described herein relate to systems and methods of determining output pixel values for target pixel values (which are beyond the waveguide color gamut) by scaling the luminance of the target pixel values and projecting the luminance scaled target values back into the waveguide gamut along the constant hue. In particular embodiments, AR/VR systems may include uLEDs display for emitting light and waveguide for coupling light to user's eyes. To display an image, the system may consider the display gamut and the waveguide gamut at each pixel location (i,j). The system may compute a simple gamut mapping operation at each pixel location. In general, the waveguide gamut may have smaller ranges compared to the display gamut. As such, at each pixel location, the color gamut may be defined by the waveguide transmission W(i,j) at that pixel location. If a desired image pixel value P_{i,j} lies within the waveguide color gamut at the location (i,j), that pixel can be rendered directly by the display. However, if the desired image pixel Pᵢⱼ falls outside the color gamut at the pixel location (i,j), the system may not be able to directly displayed, because it does not falls within the color gamut.

To solve this problem, particular embodiments of the system may perform an operation to map the pixel value to the available color gamut as defined by the waveguide. This process may be referred to as “projection.” The system may perform a projection along a line from the desired pixel value (which is out-of-gamut) to some point on the neutral axis that is inside the color gamut. The desired pixel value may be projected along the projection line until it intersects with the waveguide color gamut surface or hull. The system may use the intersection point of the projection line and the waveguide color gamut hall as the output pixel value to represent the desired pixel value (also referred to as “target pixel value”). By using the color corresponding to the intersection point as the output pixel value, the system may maximize the saturation level while at the same time preserve the hue (because the projection is along a constant hue angle). This may allow the system to render perceptually optimal waveguide-corrected content, regardless of the dynamic non-uniformity correction (DUC) ratio. The projection of an out-of-gamut target pixel value may be along a line of constant hue onto a value on the gamut hull. The gamut may be defined in XYZ tristimulus space.

This approach may work well to preserve hue, but because the target pixel value is projected along a line of constant hue and then clipped to the gamut surface, the system may lose some image details in the displayed images. This may be particularly severe for achromatic colors, because all out-of-gamut points may end up being projected onto the same location on the color gamut hull. For example, in the areas where the waveguide has greater nonuniformity and consequently the gamut is smaller, the displayed images may lose more image details.

To further improve the quality of the displayed images, particular embodiments of the system may first scale the luminance of the target pixel value before projecting it back to the color gamut. Assuming a pixel that needs to be displayed, which by definition may fall inside the display gamut but may fall outside the waveguide gamut because the display gamut may be much larger than the waveguide gamut. The system may first convert the target pixel value of the image to a luminance-chrominance space (e.g., the opponent color space). Then, the system may scale the target pixel value to the lightness range allowed by the display and waveguide at that color hue and saturation. Next, the system may perform a projection along a line from the point corresponding to the scaled target pixel value to the black point of the color gamut. The projection line may intersect with the gamut hull and the system may use the color point corresponding to the intersection point to determine the output pixel value to the display to represent the target pixel value. By scaling the luminance before the projection, the system may ensure that the color hue is maintained and may eliminate loses of the image details caused by the clipping issues. As a result, the displayed image may have the correct color hue cross the while image but may have a spatial lightness variation that corresponds to the waveguide transmission.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A and 1B show examples of quality improvements achieved by such AI/ML-based image enhancers.

FIG. 2 illustrates a block diagram of a video transmission scheme according to particular embodiments.

FIG. 3 illustrates an example of different receiving devices obtaining a video stream from a sender device and using different decoding techniques depending on their respective use cases or needs.

FIG. 4 illustrates an example method performed by a first computing device to generate and transmit an encoded video stream.

FIG. 5 illustrates an example method performed by a second computing device to generate a final output video stream from the encoded video stream.

FIG. 6 illustrates an example network environment.

FIG. 7 illustrates an example computer system.

FIG. 8A illustrates an example artificial reality system.

FIG. 8B illustrates an example augmented reality system.

FIG. 8C illustrates an example architecture of a display engine.

FIG. 8D illustrates an example graphic pipeline of the display engine for generating display image data.

FIG. 9A illustrates an example scanning waveguide display.

FIG. 9B illustrates an example scanning operation of the scanning waveguide display.

FIG. 10A illustrates an example 2D micro-LED waveguide display.

FIG. 10B illustrates an example waveguide configuration for the 2D micro-LED waveguide display.

FIG. 11 illustrate example processes of projecting a target color that is outside of the display color gamut to the display color gamut.

FIG. 12 illustrate example processes of determining an output pixel value by projecting a target color that is outside the display color gamut to the display color gamut after scaling the luminance level.

FIG. 13 illustrates an example display structure.

FIG. 14A illustrates an example pattern corresponding imagery content areas including a number of zones.

FIG. 14B illustrates an example AR image content to be displayed.

FIG. 14C illustrates an example AR image displayed on an amplitude-modulating display using a phase-modulating display as a steerable zonal backlight source.

FIG. 15 illustrates an example process using a performance curve to determine an optimized zone size.

FIG. 16 illustrates an example method of displaying an AR image using an amplitude-modulating display which uses a phase-modulating display module as a 2D steerable zonal backlight source.

FIG. 17 illustrates an example pseudo code for a bindBuffer function.

FIG. 18 illustrates an example pseudo code of bind functions in RenderCommandEncoder.

FIG. 19 illustrates a C++ implementation that prepares data for Vulcan® processing.

FIG. 20 illustrates an example where dynamic uniform buffers are used with Vulcan.

FIG. 21 illustrates how binding data may be organized within dynamic uniform buffers.

FIG. 22 illustrates an example of uploading the binding of data to the GPU.

### DESCRIPTION OF EXAMPLE EMBODIMENTS

Techniques described herein enable resource-constrained devices to achieve significant lower transmission bitrate and power/battery consumption while maintaining high image quality. Another benefit of these embodiments is that they introduce as little disruption as possible in existing pipelines for video transmission/sharing, thereby enabling easy integration with existing systems.

When it comes to video processing and transmission, reducing video bitrate has a significant impact on power consumption. Doing so is especially important for devices like AR/VR/MR headsets, since their limited power and computational resources are often the bottleneck for providing higher video quality. One way to reduce video bitrate is to use video compression techniques. However, high compression ratio comes at the cost of image quality and compression artifacts. For example, with conventional video compression codecs (e.g., H.1265), a 2× compression ratio generally would produce a compressed image with comparable image quality (based on PSNR/SSIM measurements) compared to the original. Such compression ratio, however, may not be enough to achieve the desired bitrate. For example, in order to achieve a low 1 megabit-per-second (mbps) bitrate, a 6× compression ratio may be needed. At such a high compression ratio, however, the compressed image would usually suffer from severe compression artifacts.

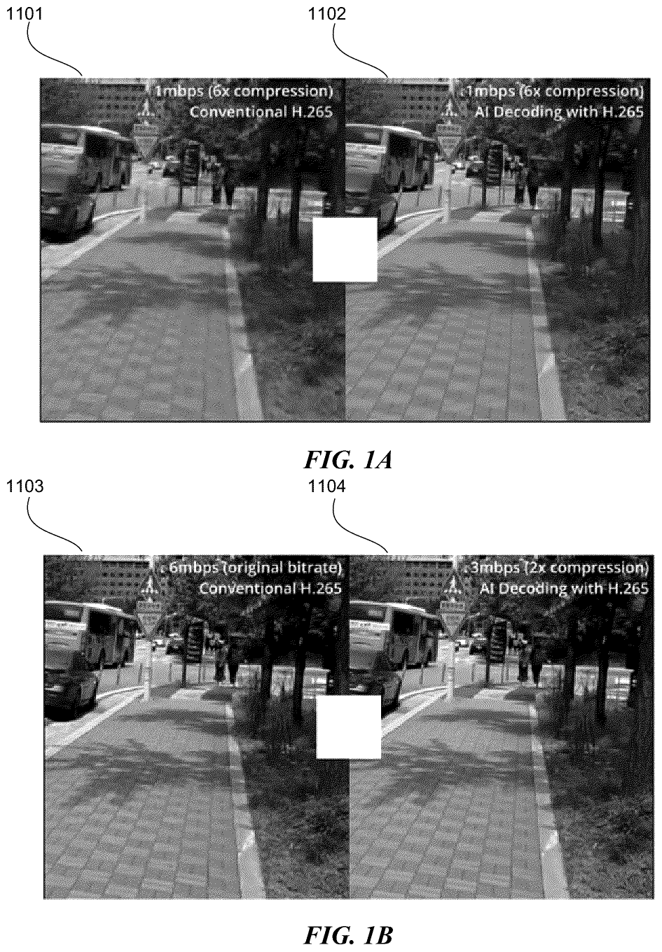

To improve the quality of compressed videos, particular embodiments may use an AI/ML-based image enhancer, which includes any suitable AI/ML-based Super Resolution and/or Compression Artifact Removal techniques. FIGS. 1A and 1B show examples of quality improvements achieved by such AI/ML-based image enhancers. In FIG. 1A, the left image 1101 is a video frame compressed at 6× compression using conventional H.1265 codec, such that the bitrate is reduced to 1 mbps. As shown, the left image 1101 suffers from severe artifacts due to the compression. The right image 1102 is an enhanced version of the left image 1101, generated by processing the left image 1101 (i.e., a 6×-compressed image) using an AI/ML-based image enhancer. As can be seen, the quality of the right image 1102 is significantly better than the right image 1101. As another example, in FIG. 1B, the left image 1103 is a video frame at its original bitrate of 6 mbps. The right image 1104 is an enhanced image generated by using an AI/ML-based image enhancer to enhance a 2×-compressed version of the left image 1103. As shown, when a frame compressed at 2× is enhanced using the AI/ML-based image enhancer, its quality is visually indistinguishable from the frame 1103 at the original bitrate.

FIGS. 1A and 1B demonstrate the potential of using AI/ML-based image enhancers to enhance the quality of a compressed video compressed using conventional techniques, such as H.1264, H.1265, or any other lossy-compression techniques that could deliver significant compression ratios. In one study, an AI/ML-based image enhancers make it feasible to reduce video file size or transmission bitrate by at least 2× without objective PSNR/SSIM quality loss, and achieving at least 6× compression while maintaining acceptable visible image quality.

The ability of such AI/ML-based image enhancers to effectively restore the resolution and quality of a compressed frame presents an opportunity to for AR/VR/MR headsets (or other types of resource-constrained devices) to share high quality video while staying within its resource budget. Specifically, particular embodiments may aggressively compress video files before transmitting them, thereby minimizing on-device power consumption. Any suitable compression technique may be used. In particular embodiments, standard video compression codecs like H.1265/H.1264 may be used, which has the benefit of allowing the sender and receiver to leverage existing hardware and software, thereby making integration easier. When the receiver receives the compressed video, it may decode the video and then apply an AI/ML-based image enhancer to restore much of its quality and resolution. In some cases, the receiver might not need to apply the AI/ML-based image enhancer if lower resolution/quality image is sufficient. For example, in the case of small-screen wearables (e.g. watch), previews without enhancements can be presented using the existing on-device hardware decoder since image quality/resolution is not as noticeable on small screens.

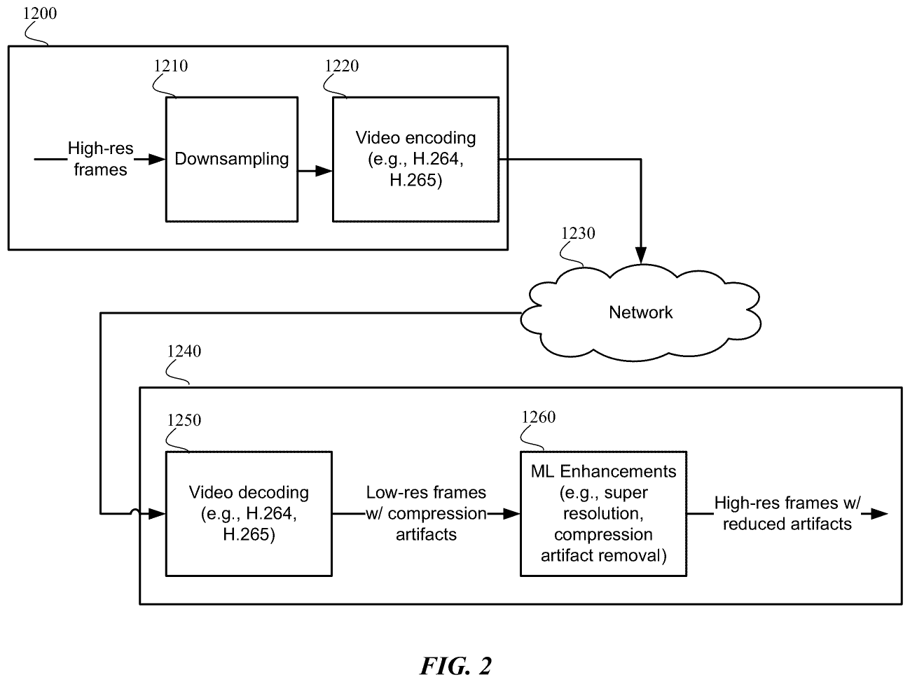

FIG. 2 illustrates a block diagram of a video transmission scheme according to particular embodiments. A capture/sender device 1200 may have a high-resolution video that the device 1200 plans to transmit. The high-resolution video may be captured by cameras of the device 1200, locally generated, or saved and retrieved from storage. The high-resolution video frames may be processed by a down sampling block 1210 to reduce its resolution (e.g., from 10 megapixels per frame to 1 megapixel per frame). The down sampling block 1210 may use 2×2 bicubic down sampling or any other suitable techniques. The resulting low-resolution video may then be compressed using a video encoder. For example, H.1265 hardware encoder may be used to compress the low-resolution video. The result may be a low-bitrate video (e.g., from a 6 mbps original video to a 1 mbps-3 mbps video at 1720p and 30 fps). The compressed low-resolution video may then be transmitted via a network 1230 to a receiver device 1240. Since the compressed low-resolution video has a much lower bitrate than the original, the capture/sender device 1200 may enjoy significant power savings.

At the receiver 1240 (e.g., a server, a companion phone of the capture/sender device 1200, or another AR/VR/MR device), a video decoding block 1250 may first perform the standard decoding process (e.g., using H.1265) to convert the video data stream back into a sequence of video frames. The decompressed video frames would have low-resolution and include compression artifacts due to the lossy compression used. Thereafter, the decompressed low-resolution video may be processed by an AI/ML-based image enhancer 1260, which may leverage any suitable AI/ML-based super resolution and/or compression artifact removal techniques. The output of the AI/ML-based image enhancer 1260 is a sequence of high-resolution video frames with little/reduced compression artifacts. In particular embodiments, further improvement in compression ratio may be achieved by incorporating reduced frame rate capture (e.g. 15 FPS) and utilizing video frame interpolation to reach the desired 24 or 30 FPS framerate.

The receiver 1240 in the embodiment above performs a two-stage process when generating a high-quality video stream. In other embodiments, the functions of decoding the compressed video and applying enhancements (e.g., super resolution and/or compression artifact removal) may be jointly performed by an AI/ML-based decoder. Such a decoder may be trained using supervised learning. For example, a neural network may be configured to process compressed low-resolution video frames and directly output uncompressed high-resolution video frames. During training, the output video frames may be compared to the corresponding original high-resolution frames, which serve as the ground truth for training the neural network. The comparison may be based on any suitable loss function to measure differences between the output frames and the ground truth frames, and the difference (or loss) may be back-propagated to update the neural network so that it would improve in performing such tasks in subsequent training iterations. Once a terminating condition for the training process is achieved (e.g., a sufficient number of training iterations has been complete or the measured loss is within a certain target threshold), the trained neural network may be used in production to decode and enhance compressed low-resolution video frames.

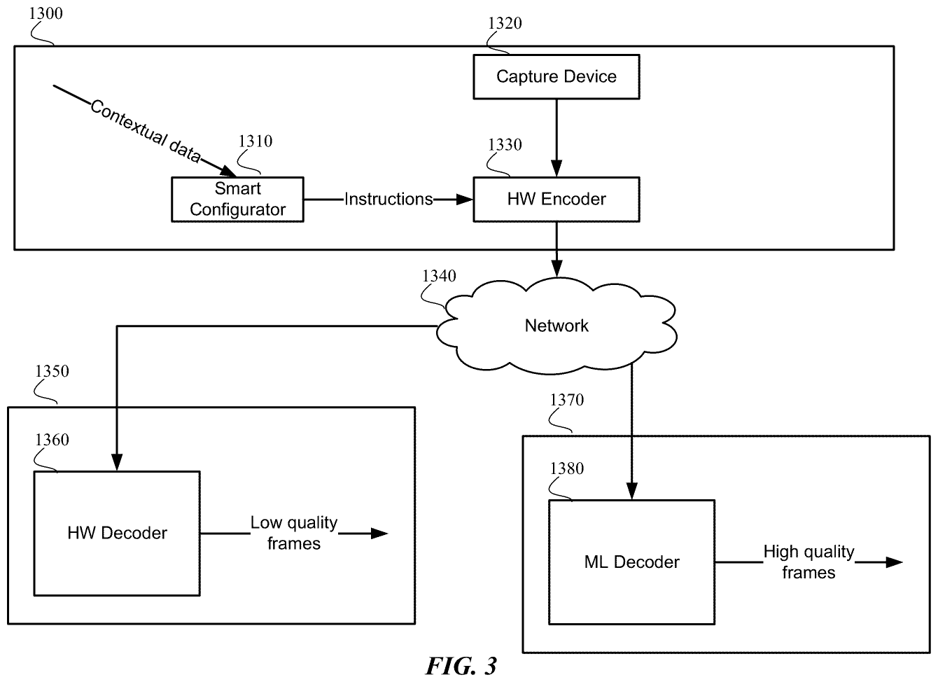

FIG. 3 illustrates an example of different receiving devices 1350, 1370 obtaining a video stream from a sender device 1300 (e.g., AR/VR/MR headset, smart watch, etc.) and using different decoding techniques depending on their respective use cases or needs. In particular embodiments, the sender device 1300 may include a capture device 1320 (e.g., a camera and/or audio recorder), a smart configurator 1310, and an encoder 1330 (e.g., a hardware encoder for H.1264/H.1265). The smart configurator 1310, which is capable of sending instructions to configure the encoder 1330, may have access to contextual data associated with the current usage context. For example, contextual data may include motion data measured by the sender device 1300 (e.g., via an Inertial Measurement Unit, accelerometer, gyroscope, visual tracking device, etc.), audio data, lighting condition of the physical environment, software application, use case, scenario, etc. Based on the contextual data, a rule engine of the smart configurator 1310 may determine the optimal configuration for the encoder 1330. For example, if the current use case or application is for streaming the captured video to a smart watch for display, the smart configurator 1310 may configure the encoder 1330 to compress and/or reduce the resolution of the video stream captured by the capture device 1320 more aggressively, knowing that the display screen and resolution of the smart watch is relatively small. In contrast, if the video stream is to be uploaded to a social media server for online sharing, the smart configurator 1310 may optimize the encoder 1330 for quality instead of compression ratio. For example, the smart configurator 1310 may configure the encoder 1330 to perform only a 2× compression if that is the maximum compression ratio for the AI/ML decoder to restore the visual quality of the compressed video frames. In yet another example, the smart configurator 1310 may also configure the frame rate (frames per second) of the compressed video stream. For instance, if the smart configurator 1310 determines that there is significant motion and/or moving objects in the scene, it may instruct the encoder 1330 to maintain a frame rate of 30 fps. When the smart configurator 1310 determines that there is little or no motion or moving objects in the scene, it may instruct the encoder 1330 to decrease the frame rate to 15 fps. The smart configurator's 1310 ability to dynamically configure the encoder 1330 allows the sender device 1300 to generate and transmit optimally compressed video based on the current context, thereby optimizing power consumption without sacrificing user experience.

The sender device 1300 may transmit the encoded video stream to one or more receiver devices 1350, 1370 via a network 1340 (e.g., Internet, Bluetooth, Wi-Fi, cellular, etc.). Each receiver device 1350, 1370 may process the encoded video stream in different ways, depending on need. For example, receiver device 1350 may be a smart watch with a small display. In this use case, the video resolution and/or quality does not need to be high. As such, the receiver device 1350 may use a standard hardware decoder 1360 to decode the video stream and output a low-quality video for downstream consumption. In contrast, receiver device 1370 may be a social media server on which the video would be posted, or it 1370 may be a smartphone. Since the intended use case of the receiver device 1370 is to present a video with optimal resolution and quality, it may use an AI/ML decoder 1380 to decode the encoded video stream from the sender device 1300.

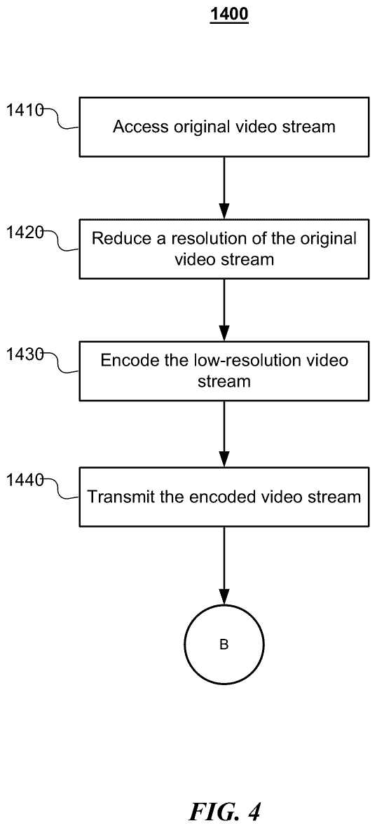

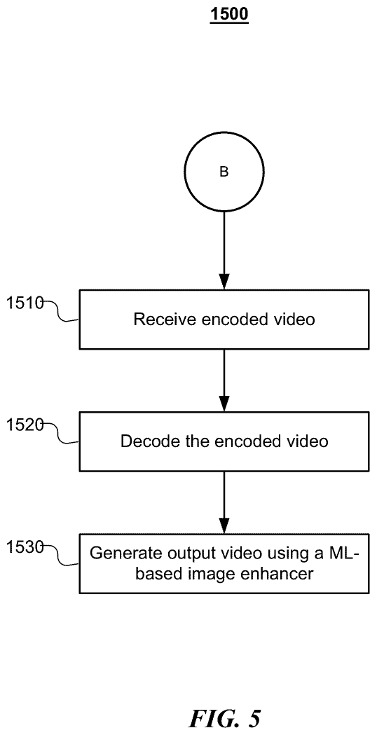

FIG. 4 illustrates an example method 1400 performed by a first computing device (e.g., a sender/capturing device) to generate and transmit an encoded video stream, and FIG. 5 illustrates an example method 1500 performed by a second computing device (e.g., receiver device) to generate a final output video stream from the encoded video stream. At step 1410, the first computing device may access an original video stream. At step 1420, the first computing device may reduce a resolution of the original video stream (e.g., via bicubic sampling) to generate a low-resolution video stream. At step 1430, the first computing device may encode the low-resolution video stream using a hardware encoder (e.g., H.1264/H.1265) to generate an encoded video stream. At step 1440, the first computing device may transmit the encoded video stream to a second computing device.

In the method 1500 shown in FIG. 5, at step 1510, the second computing device may receive the encoded video stream from the first computing device. At step 1520, the second computing device may decode the encoded video stream using a hardware decoder to generate a decoded video stream. The decoded video stream and the low-resolution video stream may have the same resolution. At step 1520, the second computing device may generate an output video stream by processing the decoded video stream using a machine-learning-based image enhancer. In particular embodiments, the machine-learning-based image enhancer comprises at least one of (1) a super resolution machine-learning model configured to increase the resolution of the decoded video stream or (2) a compression artifact removal machine-learning model configured to remove compression artifacts from the decoded video stream.

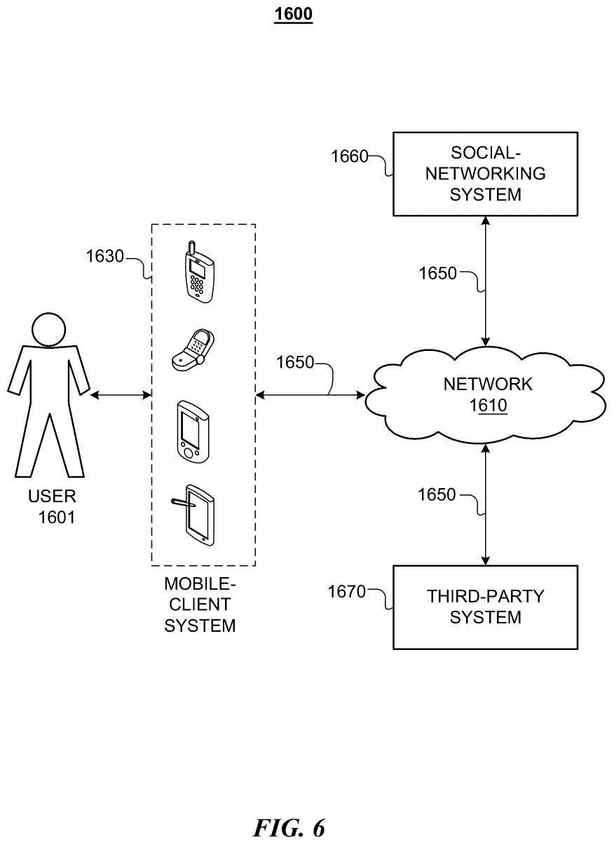

FIG. 6 illustrates an example network environment 1600 associated with a social-networking system. Network environment 1600 includes a user 1601, a client system 1630, a social-networking system 1660, and a third-party system 1670 connected to each other by a network 1610. Although FIG. 6 illustrates a particular arrangement of user 1601, client system 1630, social-networking system 1660, third-party system 1670, and network 1610, this disclosure contemplates any suitable arrangement of user 1601, client system 1630, social-networking system 1660, third-party system 1670, and network 1610. As an example and not by way of limitation, two or more of client system 1630, social-networking system 1660, and third-party system 1670 may be connected to each other directly, bypassing network 1610. As another example, two or more of client system 1630, social-networking system 1660, and third-party system 1670 may be physically or logically co-located with each other in whole or in part. Moreover, although FIG. 6 illustrates a particular number of users 1601, client systems 1630, social-networking systems 1660, third-party systems 1670, and networks 1610, this disclosure contemplates any suitable number of users 1601, client systems 1630, social-networking systems 1660, third-party systems 1670, and networks 1610. As an example and not by way of limitation, network environment 1600 may include multiple users 1601, client system 1630, social-networking systems 1660, third-party systems 1670, and networks 1610.

In particular embodiments, user 1601 may be an individual (human user), an entity (e.g., an enterprise, business, or third-party application), or a group (e.g., of individuals or entities) that interacts or communicates with or over social-networking system 1660. In particular embodiments, social-networking system 1660 may be a network-addressable computing system hosting an online social network. Social-networking system 1660 may generate, store, receive, and send social-networking data, such as, for example, user-profile data, concept-profile data, social-graph information, or other suitable data related to the online social network. Social-networking system 1660 may be accessed by the other components of network environment 1600 either directly or via network 1610. In particular embodiments, social-networking system 1660 may include an authorization server (or other suitable component(s)) that allows users 1601 to opt in to or opt out of having their actions logged by social-networking system 1660 or shared with other systems (e.g., third-party systems 1670), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. Third-party system 1670 may be accessed by the other components of network environment 1600 either directly or via network 1610. In particular embodiments, one or more users 1601 may use one or more client systems 1630 to access, send data to, and receive data from social-networking system 1660 or third-party system 1670. Client system 1630 may access social-networking system 1660 or third-party system 1670 directly, via network 1610, or via a third-party system. As an example and not by way of limitation, client system 1630 may access third-party system 1670 via social-networking system 1660. Client system 1630 may be any suitable computing device, such as, for example, a personal computer, a laptop computer, a cellular telephone, a smartphone, a tablet computer, or an augmented/virtual reality device.

This disclosure contemplates any suitable network 1610. As an example and not by way of limitation, one or more portions of network 1610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1610 may include one or more networks 1610.

Links 1650 may connect client system 1630, social-networking system 1660, and third-party system 1670 to communication network 1610 or to each other. This disclosure contemplates any suitable links 1650. In particular embodiments, one or more links 1650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1650, or a combination of two or more such links 1650. Links 1650 need not necessarily be the same throughout network environment 1600. One or more first links 1650 may differ in one or more respects from one or more second links 1650.

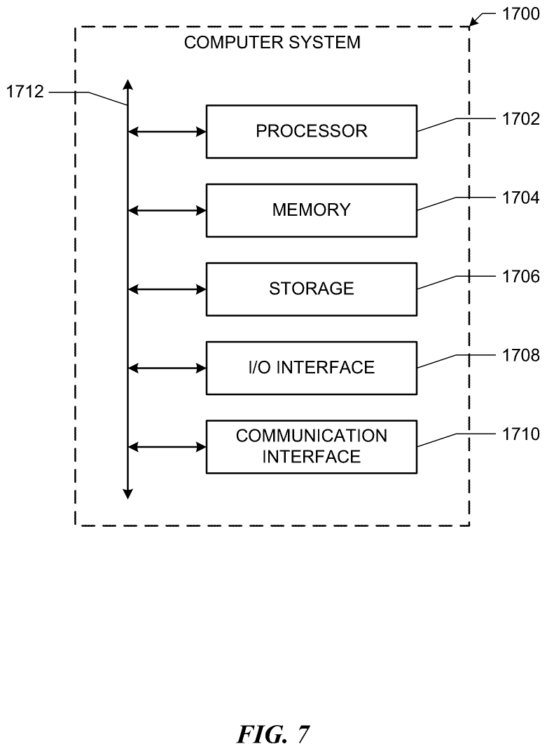

FIG. 7 illustrates an example computer system 1700. In particular embodiments, one or more computer systems 1700 perform one or more steps of one or more methods described or illustrated herein. In particular embodiments, one or more computer systems 1700 provide functionality described or illustrated herein. In particular embodiments, software running on one or more computer systems 1700 performs one or more steps of one or more methods described or illustrated herein or provides functionality described or illustrated herein. Particular embodiments include one or more portions of one or more computer systems 1700. Herein, reference to a computer system may encompass a computing device, and vice versa, where appropriate. Moreover, reference to a computer system may encompass one or more computer systems, where appropriate.

This disclosure contemplates any suitable number of computer systems 1700. This disclosure contemplates computer system 1700 taking any suitable physical form. As example and not by way of limitation, computer system 1700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1700 may include one or more computer systems 1700; be unitary or distributed; span multiple locations; span multiple machines; span multiple data centers; or reside in a cloud, which may include one or more cloud components in one or more networks. Where appropriate, one or more computer systems 1700 may perform without substantial spatial or temporal limitation one or more steps of one or more methods described or illustrated herein. As an example and not by way of limitation, one or more computer systems 1700 may perform in real time or in batch mode one or more steps of one or more methods described or illustrated herein. One or more computer systems 1700 may perform at different times or at different locations one or more steps of one or more methods described or illustrated herein, where appropriate.

In particular embodiments, computer system 1700 includes a processor 1702, memory 1704, storage 1706, an input/output (I/O) interface 1708, a communication interface 1710, and a bus 1712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1702 includes hardware for executing instructions, such as those making up a computer program. As an example and not by way of limitation, to execute instructions, processor 1702 may retrieve (or fetch) the instructions from an internal register, an internal cache, memory 1704, or storage 1706; decode and execute them; and then write one or more results to an internal register, an internal cache, memory 1704, or storage 1706. In particular embodiments, processor 1702 may include one or more internal caches for data, instructions, or addresses. This disclosure contemplates processor 1702 including any suitable number of any suitable internal caches, where appropriate. As an example and not by way of limitation, processor 1702 may include one or more instruction caches, one or more data caches, and one or more translation lookaside buffers (TLBs). Instructions in the instruction caches may be copies of instructions in memory 1704 or storage 1706, and the instruction caches may speed up retrieval of those instructions by processor 1702. Data in the data caches may be copies of data in memory 1704 or storage 1706 for instructions executing at processor 1702 to operate on; the results of previous instructions executed at processor 1702 for access by subsequent instructions executing at processor 1702 or for writing to memory 1704 or storage 1706; or other suitable data. The data caches may speed up read or write operations by processor 1702. The TLBs may speed up virtual-address translation for processor 1702. In particular embodiments, processor 1702 may include one or more internal registers for data, instructions, or addresses. This disclosure contemplates processor 1702 including any suitable number of any suitable internal registers, where appropriate. Where appropriate, processor 1702 may include one or more arithmetic logic units (ALUs); be a multi-core processor; or include one or more processors 1702. Although this disclosure describes and illustrates a particular processor, this disclosure contemplates any suitable processor.

In particular embodiments, memory 1704 includes main memory for storing instructions for processor 1702 to execute or data for processor 1702 to operate on. As an example and not by way of limitation, computer system 1700 may load instructions from storage 1706 or another source (such as, for example, another computer system 1700) to memory 1704. Processor 1702 may then load the instructions from memory 1704 to an internal register or internal cache. To execute the instructions, processor 1702 may retrieve the instructions from the internal register or internal cache and decode them. During or after execution of the instructions, processor 1702 may write one or more results (which may be intermediate or final results) to the internal register or internal cache. Processor 1702 may then write one or more of those results to memory 1704. In particular embodiments, processor 1702 executes only instructions in one or more internal registers or internal caches or in memory 1704 (as opposed to storage 1706 or elsewhere) and operates only on data in one or more internal registers or internal caches or in memory 1704 (as opposed to storage 1706 or elsewhere). One or more memory buses (which may each include an address bus and a data bus) may couple processor 1702 to memory 1704. Bus 1712 may include one or more memory buses, as described below. In particular embodiments, one or more memory management units (MMUs) reside between processor 1702 and memory 1704 and facilitate accesses to memory 1704 requested by processor 1702. In particular embodiments, memory 1704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1704 may include one or more memories 1704, where appropriate. Although this disclosure describes and illustrates particular memory, this disclosure contemplates any suitable memory.

In particular embodiments, storage 1706 includes mass storage for data or instructions. As an example and not by way of limitation, storage 1706 may include a hard disk drive (HDD), a floppy disk drive, flash memory, an optical disc, a magneto-optical disc, magnetic tape, or a Universal Serial Bus (USB) drive or a combination of two or more of these. Storage 1706 may include removable or non-removable (or fixed) media, where appropriate. Storage 1706 may be internal or external to computer system 1700, where appropriate. In particular embodiments, storage 1706 is non-volatile, solid-state memory. In particular embodiments, storage 1706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1706 taking any suitable physical form. Storage 1706 may include one or more storage control units facilitating communication between processor 1702 and storage 1706, where appropriate. Where appropriate, storage 1706 may include one or more storages 1706. Although this disclosure describes and illustrates particular storage, this disclosure contemplates any suitable storage.

In particular embodiments, I/O interface 1708 includes hardware, software, or both, providing one or more interfaces for communication between computer system 1700 and one or more I/O devices. Computer system 1700 may include one or more of these I/O devices, where appropriate. One or more of these I/O devices may enable communication between a person and computer system 1700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1708 for them. Where appropriate, I/O interface 1708 may include one or more device or software drivers enabling processor 1702 to drive one or more of these I/O devices. I/O interface 1708 may include one or more I/O interfaces 1708, where appropriate. Although this disclosure describes and illustrates a particular I/O interface, this disclosure contemplates any suitable I/O interface.

In particular embodiments, communication interface 1710 includes hardware, software, or both providing one or more interfaces for communication (such as, for example, packet-based communication) between computer system 1700 and one or more other computer systems 1700 or one or more networks. As an example and not by way of limitation, communication interface 1710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1710 for it. As an example and not by way of limitation, computer system 1700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1700 may include any suitable communication interface 1710 for any of these networks, where appropriate. Communication interface 1710 may include one or more communication interfaces 1710, where appropriate. Although this disclosure describes and illustrates a particular communication interface, this disclosure contemplates any suitable communication interface.

In particular embodiments, bus 1712 includes hardware, software, or both coupling components of computer system 1700 to each other. As an example and not by way of limitation, bus 1712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1712 may include one or more buses 1712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

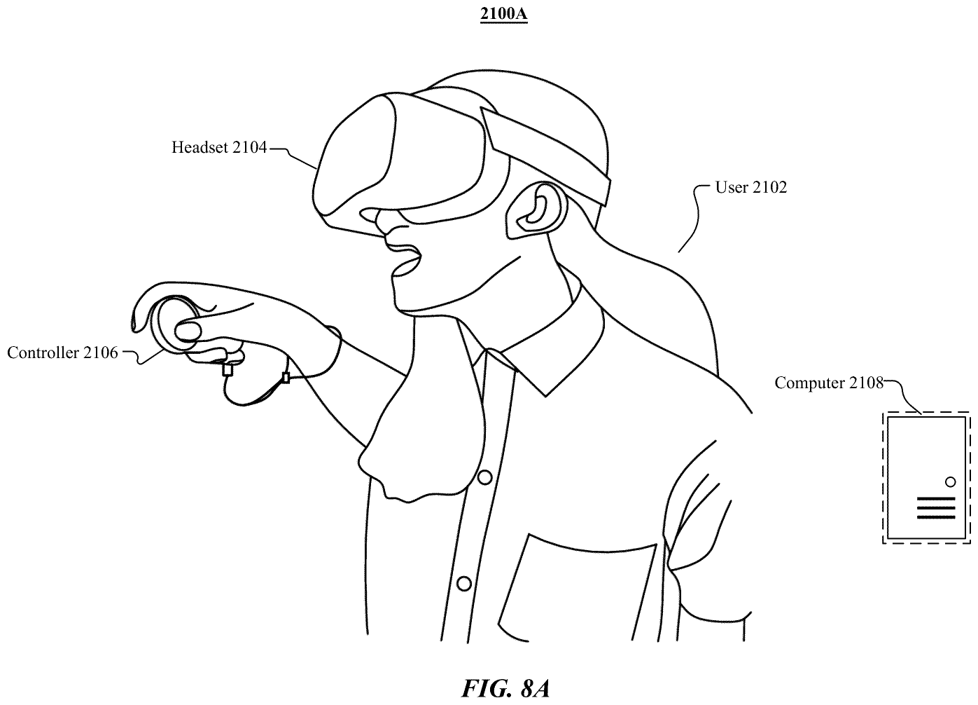

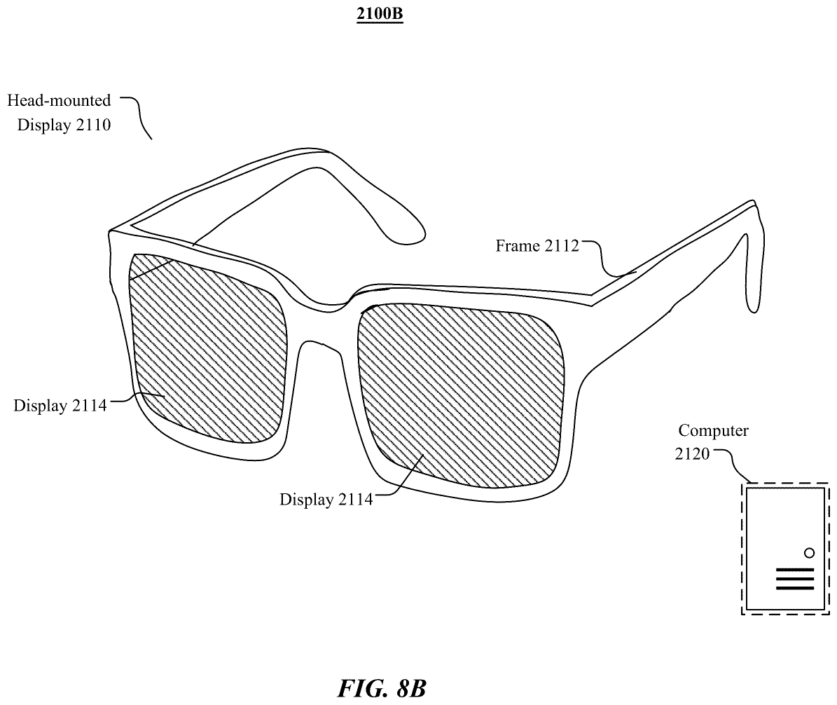

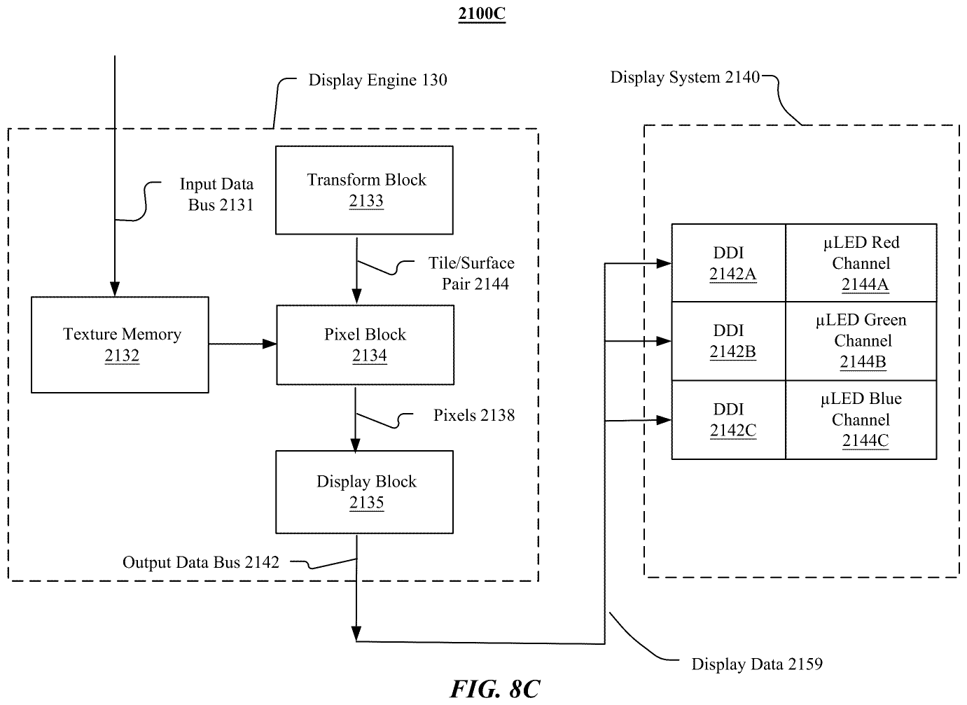

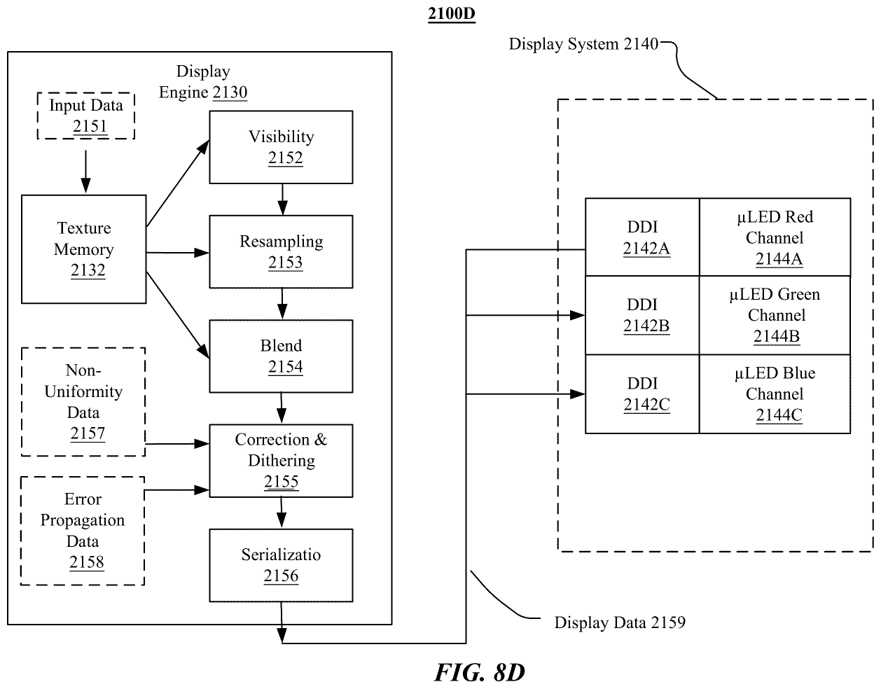

FIG. 8A illustrates an example artificial reality system 2100A. In particular embodiments, the artificial reality system 2100 may comprise a headset 2104, a controller 2106, and a computing system 2108. A user 2102 may wear the headset 2104 that may display visual artificial reality content to the user 2102. The headset 2104 may include an audio device that may provide audio artificial reality content to the user 2102. The headset 2104 may include one or more cameras which can capture images and videos of environments. The headset 2104 may include an eye tracking system to determine the vergence distance of the user 2102. The headset 2104 may be referred as a head-mounted display (HDM). The controller 2106 may comprise a trackpad and one or more buttons. The controller 2106 may receive inputs from the user 2102 and relay the inputs to the computing system 2108. The controller 2206 may also provide haptic feedback to the user 2102. The computing system 2108 may be connected to the headset 2104 and the controller 2106 through cables or wireless connections. The computing system 2108 may control the headset 2104 and the controller 2106 to provide the artificial reality content to and receive inputs from the user 2102. The computing system 2108 may be a standalone host computer system, an on-board computer system integrated with the headset 2104, a mobile device, or any other hardware platform capable of providing artificial reality content to and receiving inputs from the user 2102.

FIG. 8B illustrates an example augmented reality system 2100B. The augmented reality system 2100B may include a head-mounted display (HMD) 2110 (e.g., glasses) comprising a frame 2112, one or more displays 2114, and a computing system 2120. The displays 2114 may be transparent or translucent allowing a user wearing the HMD 2110 to look through the displays 2114 to see the real world and displaying visual artificial reality content to the user at the same time. The HMD 2110 may include an audio device that may provide audio artificial reality content to users. The HMD 2110 may include one or more cameras which can capture images and videos of environments. The HMD 2110 may include an eye tracking system to track the vergence movement of the user wearing the HMD 2110. The augmented reality system 2100B may further include a controller comprising a trackpad and one or more buttons. The controller may receive inputs from users and relay the inputs to the computing system 2120. The controller may also provide haptic feedback to users. The computing system 2120 may be connected to the HMD 2110 and the controller through cables or wireless connections. The computing system 2120 may control the HMD 2110 and the controller to provide the augmented reality content to and receive inputs from users. The computing system 2120 may be a standalone host computer system, an on-board computer system integrated with the HMD 2110, a mobile device, or any other hardware platform capable of providing artificial reality content to and receiving inputs from users.

FIG. 8C illustrates an example architecture 2100C of a display engine 2130. In particular embodiments, the processes and methods as described in this disclosure may be embodied or implemented within a display engine 2130 (e.g., in the display block 2135). The display engine 2130 may include, for example, but is not limited to, a texture memory 2132, a transform block 2133, a pixel block 2134, a display block 2135, input data bus 2131, output data bus 2142, etc. In particular embodiments, the display engine 2130 may include one or more graphic pipelines for generating images to be rendered on the display. For example, the display engine may use the graphic pipeline(s) to generate a series of subframe images based on a mainframe image and a viewpoint or view angle of the user as measured by one or more eye tracking sensors. The mainframe image may be generated or/and loaded in to the system at a mainframe rate of 30-90 Hz and the subframe rate may be generated at a subframe rate of 1-2 kHz. In particular embodiments, the display engine 2130 may include two graphic pipelines for the user's left and right eyes. One of the graphic pipelines may include or may be implemented on the texture memory 2132, the transform block 2133, the pixel block 2134, the display block 2135, etc. The display engine 2130 may include another set of transform block, pixel block, and display block for the other graphic pipeline. The graphic pipeline(s) may be controlled by a controller or control block (not shown) of the display engine 2130. In particular embodiments, the texture memory 2132 may be included within the control block or may be a memory unit external to the control block but local to the display engine 2130. One or more of the components of the display engine 2130 may be configured to communicate via a high-speed bus, shared memory, or any other suitable methods. This communication may include transmission of data as well as control signals, interrupts or/and other instructions. For example, the texture memory 2132 may be configured to receive image data through the input data bus 2211. As another example, the display block 2135 may send the pixel values to the display system 2140 through the output data bus 2142. In particular embodiments, the display system 2140 may include three color channels (e.g., 2114A, 2114B, 2114C) with respective display driver ICs (DDIs) of 2142A, 2142B, and 2143B. In particular embodiments, the display system 2140 may include, for example, but is not limited to, light-emitting diode (LED) displays, organic light-emitting diode (OLED) displays, active matrix organic light-emitting diode (AMLED) displays, liquid crystal display (LCD), micro light-emitting diode (μLED) display, electroluminescent displays (ELDs), or any suitable displays.

In particular embodiments, the display engine 2130 may include a controller block (not shown). The control block may receive data and control packages such as position data and surface information from controllers external to the display engine 2130 though one or more data buses. For example, the control block may receive input stream data from a body wearable computing system. The input data stream may include a series of mainframe images generated at a mainframe rate of 30-90 Hz. The input stream data including the mainframe images may be converted to the required format and stored into the texture memory 2132. In particular embodiments, the control block may receive input from the body wearable computing system and initialize the graphic pipelines in the display engine to prepare and finalize the image data for rendering on the display. The data and control packets may include information related to, for example, one or more surfaces including texel data, position data, and additional rendering instructions. The control block may distribute data as needed to one or more other blocks of the display engine 2130. The control block may initiate the graphic pipelines for processing one or more frames to be displayed. In particular embodiments, the graphic pipelines for the two eye display systems may each include a control block or share the same control block.

In particular embodiments, the transform block 2133 may determine initial visibility information for surfaces to be displayed in the artificial reality scene. In general, the transform block 2133 may cast rays from pixel locations on the screen and produce filter commands (e.g., filtering based on bilinear or other types of interpolation techniques) to send to the pixel block 2134. The transform block 2133 may perform ray casting from the current viewpoint of the user (e.g., determined using the headset's inertial measurement units, eye tracking sensors, and/or any suitable tracking/localization algorithms, such as simultaneous localization and mapping (SLAM)) into the artificial scene where surfaces are positioned and may produce tile/surface pairs 2144 to send to the pixel block 2134. In particular embodiments, the transform block 2133 may include a four-stage pipeline as follows. A ray caster may issue ray bundles corresponding to arrays of one or more aligned pixels, referred to as tiles (e.g., each tile may include 16×16 aligned pixels). The ray bundles may be warped, before entering the artificial reality scene, according to one or more distortion meshes. The distortion meshes may be configured to correct geometric distortion effects stemming from, at least, the eye display systems the headset system. The transform block 2133 may determine whether each ray bundle intersects with surfaces in the scene by comparing a bounding box of each tile to bounding boxes for the surfaces. If a ray bundle does not intersect with an object, it may be discarded. After the tile-surface intersections are detected, the corresponding tile/surface pairs may be passed to the pixel block 2134.

In particular embodiments, the pixel block 2134 may determine pixel values or grayscale values for the pixels based on the tile-surface pairs. The pixel values for each pixel may be sampled from the texel data of surfaces received and stored in texture memory 2132. The pixel block 2134 may receive tile-surface pairs from the transform block 2133 and may schedule bilinear filtering using one or more filer blocks. For each tile-surface pair, the pixel block 2134 may sample color information for the pixels within the tile using pixel values corresponding to where the projected tile intersects the surface. The pixel block 2134 may determine pixel values based on the retrieved texels (e.g., using bilinear interpolation). In particular embodiments, the pixel block 2134 may process the red, green, and blue color components separately for each pixel. In particular embodiments, the display may include two pixel blocks for the two eye display systems. The two pixel blocks of the two eye display systems may work independently and in parallel with each other. The pixel block 2134 may then output its color determinations (e.g., pixels 2138) to the display block 2135. In particular embodiments, the pixel block 2134 may composite two or more surfaces into one surface to when the two or more surfaces have overlapping areas. A composed surface may need less computational resources (e.g., computational units, memory, power, etc.) for the resampling process.

In particular embodiments, the display block 2135 may receive pixel values from the pixel block 2134, covert the format of the data to be more suitable for the scanline output of the display, apply one or more brightness corrections to the pixel values, and prepare the pixel values for output to the display. In particular embodiments, the display block 2135 may each include a row buffer and may process and store the pixel data received from the pixel block 2134. The pixel data may be organized in quads (e.g., 2×2 pixels per quad) and tiles (e.g., 16×16 pixels per tile). The display block 2135 may convert tile-order pixel values generated by the pixel block 2134 into scanline or row-order data, which may be required by the physical displays. The brightness corrections may include any required brightness correction, gamma mapping, and dithering. The display block 2135 may output the corrected pixel values directly to the driver of the physical display (e.g., pupil display) or may output the pixel values to a block external to the display engine 2130 in a variety of formats. For example, the eye display systems of the headset system may include additional hardware or software to further customize backend color processing, to support a wider interface to the display, or to optimize display speed or fidelity.

In particular embodiments, the dithering methods and processes (e.g., spatial dithering method, temporal dithering methods, and spatio-temporal methods) as described in this disclosure may be embodied or implemented in the display block 2135 of the display engine 2130. In particular embodiments, the display block 2135 may include a model-based dithering algorithm or a dithering model for each color channel and send the dithered results of the respective color channels to the respective display driver interfaces (DDIs) (e.g., 2142A, 2142B, 2142C) of display system 2140. In particular embodiments, before sending the pixel values to the respective display driver interfaces (e.g., 2142A, 2142B, 2142C), the display block 2135 may further include one or more algorithms for correcting, for example, pixel non-uniformity, LED non-ideality, waveguide non-uniformity, display defects (e.g., dead pixels), etc.

In particular embodiments, graphics applications (e.g., games, maps, content-providing apps, etc.) may build a scene graph, which is used together with a given view position and point in time to generate primitives to render on a GPU or display engine. The scene graph may define the logical and/or spatial relationship between objects in the scene. In particular embodiments, the display engine 2130 may also generate and store a scene graph that is a simplified form of the full application scene graph. The simplified scene graph may be used to specify the logical and/or spatial relationships between surfaces (e.g., the primitives rendered by the display engine 2130, such as quadrilaterals or contours, defined in 3D space, that have corresponding textures generated based on the mainframe rendered by the application). Storing a scene graph allows the display engine 2130 to render the scene to multiple display frames and to adjust each element in the scene graph for the current viewpoint (e.g., head position), the current object positions (e.g., they could be moving relative to each other) and other factors that change per display frame. In addition, based on the scene graph, the display engine 2130 may also adjust for the geometric and color distortion introduced by the display subsystem and then composite the objects together to generate a frame. Storing a scene graph allows the display engine 2130 to approximate the result of doing a full render at the desired high frame rate, while actually running the GPU or display engine 2130 at a significantly lower rate.

FIG. 8D illustrates an example graphic pipeline 2100D of the display engine 2130 for generating display image data. In particular embodiments, the graphic pipeline 2100D may include a visibility step 2152, where the display engine 2130 may determine the visibility of one or more surfaces received from the body wearable computing system. The visibility step 2152 may be performed by the transform block (e.g., 22133 in FIG. 8C) of the display engine 2130. The display engine 2130 may receive (e.g., by a control block or a controller) input data 2151 from the body-wearable computing system. The input data 2151 may include one or more surfaces, texel data, position data, RGB data, and rendering instructions from the body wearable computing system. The input data 2151 may include mainframe images with 30-90 frames per second (FPS). The main frame image may have color depth of, for example, 24 bits per pixel. The display engine 2130 may process and save the received input data 2151 in the texel memory 2132. The received data may be passed to the transform block 2133 which may determine the visibility information for surfaces to be displayed. The transform block 2133 may cast rays for pixel locations on the screen and produce filter commands (e.g., filtering based on bilinear or other types of interpolation techniques) to send to the pixel block 2134. The transform block 2133 may perform ray casting from the current viewpoint of the user (e.g., determined using the headset's inertial measurement units, eye trackers, and/or any suitable tracking/localization algorithms, such as simultaneous localization and mapping (SLAM)) into the artificial scene where surfaces are positioned and produce surface-tile pairs to send to the pixel block 2134.

In particular embodiments, the graphic pipeline 2100D may include a resampling step 2153, where the display engine 2130 may determine the pixel values from the tile-surfaces pairs to produce pixel values. The resampling step 2153 may be performed by the pixel block 2134 in FIG. 8C) of the display engine 2130. The pixel block 2134 may receive tile-surface pairs from the transform block 2133 and may schedule bilinear filtering. For each tile-surface pair, the pixel block 2134 may sample color information for the pixels within the tile using pixel values corresponding to where the projected tile intersects the surface. The pixel block 2134 may determine pixel values based on the retrieved texels (e.g., using bilinear interpolation) and output the determined pixel values to the respective display block 2135.

In particular embodiments, the graphic pipeline 2100D may include a bend step 2154, a correction and dithering step 2155, a serialization step 2156, etc. In particular embodiments, the bend step, correction and dithering step, and serialization steps of 2154, 2155, and 2156 may be performed by the display block (e.g., 2135 in FIG. 8C) of the display engine 2130. The display engine 2130 may blend the display content for display content rendering, apply one or more brightness corrections to the pixel values, perform one or more dithering algorithms for dithering the quantization errors both spatially and temporally, serialize the pixel values for scanline output for the physical display, and generate the display data 2159 suitable for the display system 2140. The display engine 2130 may send the display data 2159 to the display system 2140. In particular embodiments, the display system 2140 may include three display driver Ics (e.g., 2142A, 2142B, 2142C) for the pixels of the three color channels of RGB (e.g., 2144A, 2144B, 2144C).

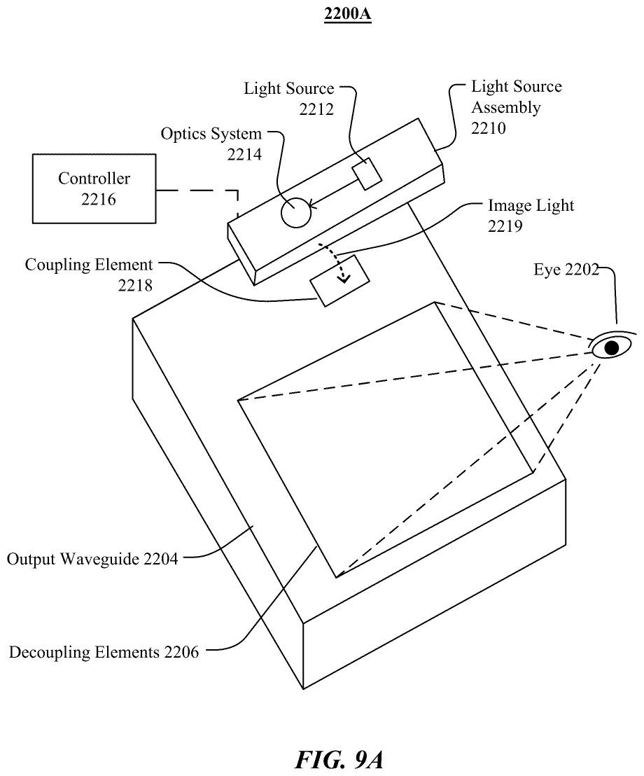

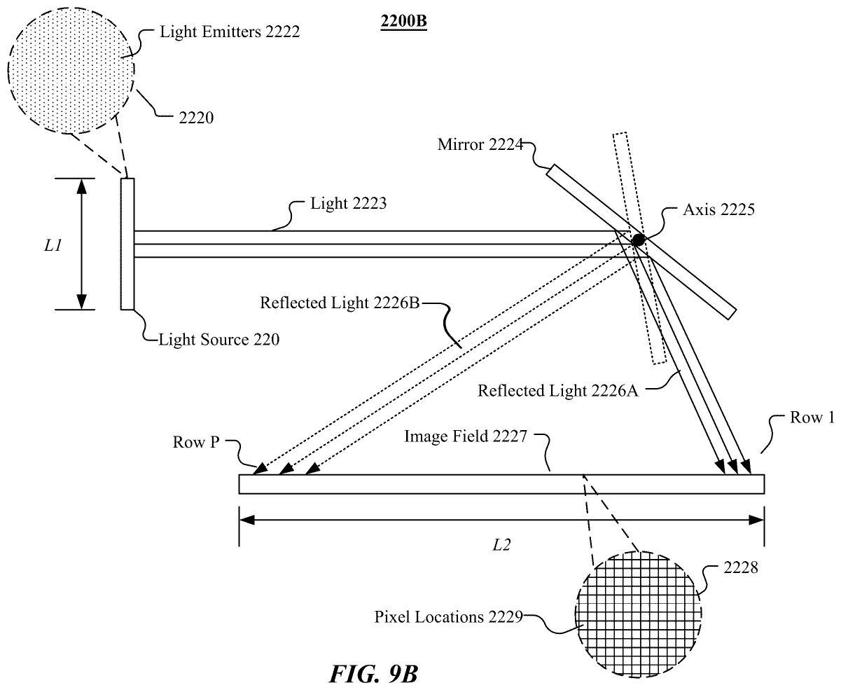

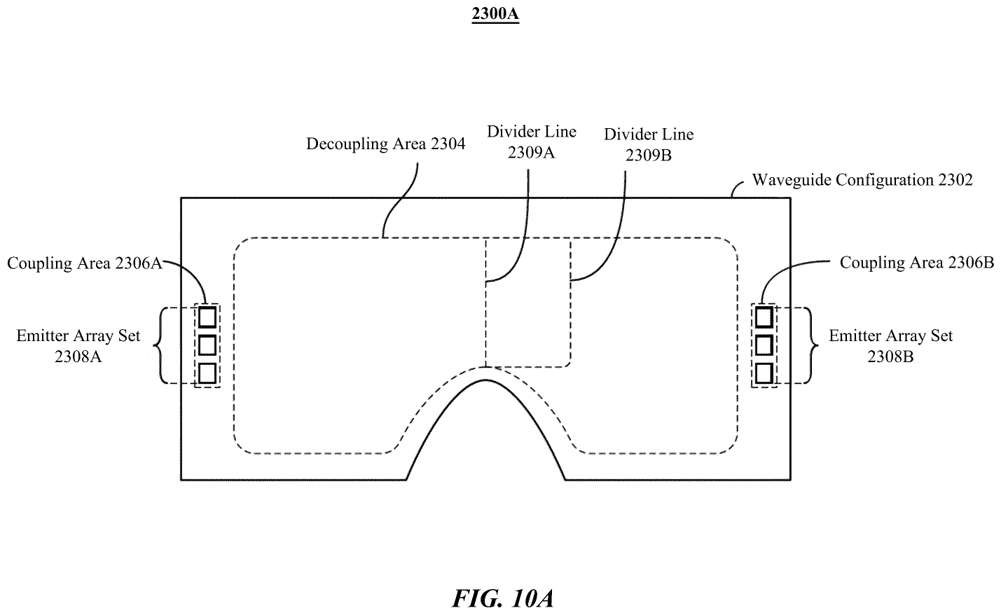

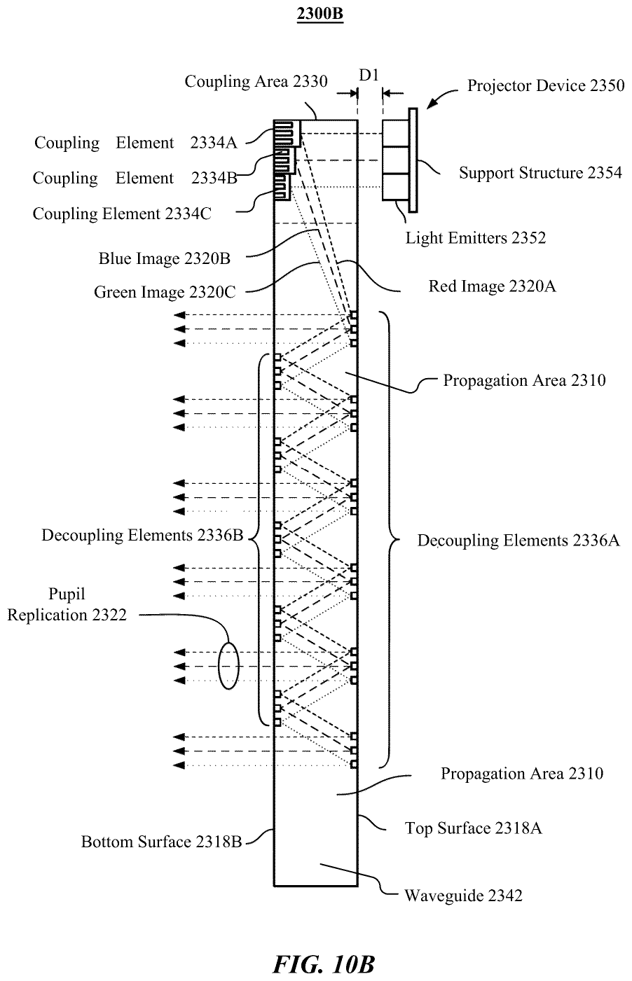

FIG. 9A illustrates an example scanning waveguide display 2200A. In particular embodiments, the head-mounted display (HMD) of the AR/VR system may include a near eye display (NED) which may be a scanning waveguide display 2200A. The scanning waveguide display 2200A may include a light source assembly 2210, an output waveguide 2204, a controller 2216, etc. The scanning waveguide display 2200A may provide images for both eyes or for a single eye. For purposes of illustration, FIG. 10A shows the scanning waveguide display 2200A associated with a single eye 2202. Another scanning waveguide display (not shown) may provide image light to the other eye of the user and the two scanning waveguide displays may share one or more components or may be separated. The light source assembly 2210 may include a light source 2212 and an optics system 2214. The light source 2212 may include an optical component that could generate image light using an array of light emitters. The light source 2212 may generate image light including, for example, but not limited to, red image light, blue image light, green image light, infra-red image light, etc. The optics system 2214 may perform a number of optical processes or operations on the image light generated by the light source 2212. The optical processes or operations performed by the optics systems 2214 may include, for example, but are not limited to, light focusing, light combining, light conditioning, scanning, etc.

In particular embodiments, the optics system 2214 may include a light combining assembly, a light conditioning assembly, a scanning mirror assembly, etc. The light source assembly 2210 may generate and output an image light 2219 to a coupling element 2218 of the output waveguide 2204. The output waveguide 2204 may be an optical waveguide that could output image light to the user eye 2202. The output waveguide 2204 may receive the image light 2219 at one or more coupling elements 2218 and guide the received image light to one or more decoupling elements 2206. The coupling element 2218 may be, for example, but is not limited to, a diffraction grating, a holographic grating, any other suitable elements that can couple the image light 2219 into the output waveguide 2204, or a combination thereof. As an example and not by way of limitation, if the coupling element 2350 is a diffraction grating, the pitch of the diffraction grating may be chosen to allow the total internal reflection to occur and the image light 2219 to propagate internally toward the decoupling element 2206. The pitch of the diffraction grating may be in the range of 2300 nm to 2600 nm. The decoupling element 2206 may decouple the total internally reflected image light from the output waveguide 2204. The decoupling element 2206 may be, for example, but is not limited to, a diffraction grating, a holographic grating, any other suitable element that can decouple image light out of the output waveguide 2204, or a combination thereof. As an example and not by way of limitation, if the decoupling element 2206 is a diffraction grating, the pitch of the diffraction grating may be chosen to cause incident image light to exit the output waveguide 2204. The orientation and position of the image light exiting from the output waveguide 2204 may be controlled by changing the orientation and position of the image light 2219 entering the coupling element 2218. The pitch of the diffraction grating may be in the range of 2300 nm to 2600 nm.

In particular embodiments, the output waveguide 2204 may be composed of one or more materials that can facilitate total internal reflection of the image light 2219. The output waveguide 2204 may be composed of one or more materials including, for example, but not limited to, silicon, plastic, glass, polymers, or some combination thereof. The output waveguide 2204 may have a relatively small form factor. As an example and not by way of limitation, the output waveguide 2204 may be approximately 50 mm wide along X-dimension, 30 mm long along Y-dimension and 0.5-1 mm thick along Z-dimension. The controller 2216 may control the scanning operations of the light source assembly 2210. The controller 2216 may determine scanning instructions for the light source assembly 2210 based at least on the one or more display instructions for rendering one or more images. The display instructions may include an image file (e.g., bitmap) and may be received from, for example, a console or computer of the AR/VR system. Scanning instructions may be used by the light source assembly 2210 to generate image light 2219. The scanning instructions may include, for example, but are not limited to, an image light source type (e.g., monochromatic source, polychromatic source), a scanning rate, a scanning apparatus orientation, one or more illumination parameters, or some combination thereof. The controller 2216 may include a combination of hardware, software, firmware, or any suitable components supporting the functionality of the controller 2216.

FIG. 9B illustrates an example scanning operation of a scanning waveguide display 2200B. The light source 2220 may include an array of light emitters 2222 (as represented by the dots in inset) with multiple rows and columns. The light 2223 emitted by the light source 2220 may include a set of collimated beams of light emitted by each column of light emitters 2222. Before reaching the mirror 2224, the light 2223 may be conditioned by different optical devices such as the conditioning assembly (not shown). The mirror 2224 may reflect and project the light 2223 from the light source 2220 to the image field 2227 by rotating about an axis 2225 during scanning operations. The mirror 2224 may be a microelectromechanical system (MEMS) mirror or any other suitable mirror. As the mirror 2224 rotates about the axis 2225, the light 2223 may be projected to a different part of the image field 2227, as illustrated by the reflected part of the light 2226A in solid lines and the reflected part of the light 2226B in dash lines.

In particular embodiments, the image field 2227 may receive the light 2226A-B as the mirror 2224 rotates about the axis 2225 to project the light 2226A-B in different directions. For example, the image field 2227 may correspond to a portion of the coupling element 2218 or a portion of the decoupling element 2206 in FIG. 9A. In particular embodiments, the image field 2227 may include a surface of the coupling element 2206. The image formed on the image field 2227 may be magnified as light travels through the output waveguide 2220. In particular embodiments, the image field 2227 may not include an actual physical structure but include an area to which the image light is projected to form the images. The image field 2227 may also be referred to as a scan field. When the light 2223 is projected to an area of the image field 2227, the area of the image field 2227 may be illuminated by the light 2223. The image field 2227 may include a matrix of pixel locations 2229 (represented by the blocks in inset 2228) with multiple rows and columns. The pixel location 2229 may be spatially defined in the area of the image field 2227 with a pixel location corresponding to a single pixel. In particular embodiments, the pixel locations 2229 (or the pixels) in the image field 2227 may not include individual physical pixel elements. Instead, the pixel locations 2229 may be spatial areas that are defined within the image field 2227 and divide the image field 2227 into pixels. The sizes and locations of the pixel locations 2229 may depend on the projection of the light 2223 from the light source 2220. For example, at a given rotation angle of the mirror 2224, light beams emitted from the light source 2220 may fall on an area of the image field 2227. As such, the sizes and locations of pixel locations 2229 of the image field 2227 may be defined based on the location of each projected light beam. In particular embodiments, a pixel location 2229 may be subdivided spatially into subpixels (not shown). For example, a pixel location 2229 may include a red subpixel, a green subpixel, and a blue subpixel. The red, green and blue subpixels may correspond to respective locations at which one or more red, green and blue light beams are projected. In this case, the color of a pixel may be based on the temporal and/or spatial average of the pixel's subpixels.

In particular embodiments, the light emitters 2222 may illuminate a portion of the image field 2227 (e.g., a particular subset of multiple pixel locations 2229 on the image field 2227) with a particular rotation angle of the mirror 2224. In particular embodiment, the light emitters 2222 may be arranged and spaced such that a light beam from each of the light emitters 2222 is projected on a corresponding pixel location 2229. In particular embodiments, the light emitters 2222 may include a number of light-emitting elements (e.g., micro-LEDs) to allow the light beams from a subset of the light emitters 2222 to be projected to a same pixel location 2229. In other words, a subset of multiple light emitters 2222 may collectively illuminate a single pixel location 2229 at a time. As an example and not by way of limitation, a group of light emitter including eight light-emitting elements may be arranged in a line to illuminate a single pixel location 2229 with the mirror 2224 at a given orientation angle.

In particular embodiments, the number of rows and columns of light emitters 2222 of the light source 2220 may or may not be the same as the number of rows and columns of the pixel locations 2229 in the image field 2227. In particular embodiments, the number of light emitters 2222 in a row may be equal to the number of pixel locations 2229 in a row of the image field 2227 while the light emitters 2222 may have fewer columns than the number of pixel locations 2229 of the image field 2227. In particular embodiments, the light source 2220 may have the same number of columns of light emitters 2222 as the number of columns of pixel locations 2229 in the image field 2227 but fewer rows. As an example and not by way of limitation, the light source 2220 may have about 21280 columns of light emitters 2222 which may be the same as the number of columns of pixel locations 2229 of the image field 2227, but only a handful rows of light emitters 2222. The light source 2220 may have a first length L1 measured from the first row to the last row of light emitters 2222. The image field 2530 may have a second length L2, measured from the first row (e.g., Row 1) to the last row (e.g., Row P) of the image field 2227. The L2 may be greater than L1 (e.g., L2 is 50 to 10,2000 times greater than L1).

In particular embodiments, the number of rows of pixel locations 2229 may be larger than the number of rows of light emitters 2222. The display device 2200B may use the mirror 2224 to project the light 2223 to different rows of pixels at different time. As the mirror 2520 rotates and the light 2223 scans through the image field 2227, an image may be formed on the image field 2227. In some embodiments, the light source 2220 may also has a smaller number of columns than the image field 2227. The mirror 2224 may rotate in two dimensions to fill the image field 2227 with light, for example, using a raster-type scanning process to scan down the rows then moving to new columns in the image field 2227. A complete cycle of rotation of the mirror 2224 may be referred to as a scanning period which may be a predetermined cycle time during which the entire image field 2227 is completely scanned. The scanning of the image field 2227 may be determined and controlled by the mirror 2224 with the light generation of the display device 2200B being synchronized with the rotation of the mirror 2224. As an example and not by way of limitation, the mirror 2224 may start at an initial position projecting light to Row 1 of the image field 2227, and rotate to the last position that projects light to Row P of the image field 2227, and then rotate back to the initial position during one scanning period. An image (e.g., a frame) may be formed on the image field 2227 per scanning period. The frame rate of the display device 2200B may correspond to the number of scanning periods in a second. As the mirror 2224 rotates, the light may scan through the image field to form images. The actual pixel value and light intensity or brightness of a given pixel location 2229 may be a temporal sum of the color various light beams illuminating the pixel location during the scanning period. After completing a scanning period, the mirror 2224 may revert back to the initial position to project light to the first few rows of the image field 2227 with a new set of driving signals being fed to the light emitters 2222. The same process may be repeated as the mirror 2224 rotates in cycles to allow different frames of images to be formed in the scanning field 2227.

FIG. 10A illustrates an example 2D micro-LED waveguide display 2300A. In particular embodiments, the display 2300A may include an elongate waveguide configuration 2302 that may be wide or long enough to project images to both eyes of a user. The waveguide configuration 2302 may include a decoupling area 2304 covering both eyes of the user. In order to provide images to both eyes of the user through the waveguide configuration 2302, multiple coupling areas 2306A-B may be provided in a top surface of the waveguide configuration 2302. The coupling areas 2306A and 2306B may include multiple coupling elements to receive image light from light emitter array sets 2308A and 2308B, respectively. Each of the emitter array sets 2308A-B may include a number of monochromatic emitter arrays including, for example, but not limited to, a red emitter array, a green emitter array, and a blue emitter array. In particular embodiments, the emitter array sets 2308A-B may further include a white emitter array or an emitter array emitting other colors or any combination of any multiple colors. In particular embodiments, the waveguide configuration 2302 may have the emitter array sets 2308A and 2308B covering approximately identical portions of the decoupling area 2304 as divided by the divider line 2309A. In particular embodiments, the emitter array sets 2308A and 2308B may provide images to the waveguide of the waveguide configuration 2302 asymmetrically as divided by the divider line 2309B. For example, the emitter array set 2308A may provide image to more than half of the decoupling area 2304. In particular embodiments, the emitter array sets 2308A and 2308B may be arranged at opposite sides (e.g., 2180° apart) of the waveguide configuration 2302 as shown in FIG. 10B. In other embodiments, the emitter array sets 2308A and 2308B may be arranged at any suitable angles. The waveguide configuration 2302 may be planar or may have a curved cross-sectional shape to better fit to the face/head of a user.

FIG. 10B illustrates an example waveguide configuration 2300B for the 2D micro-LED waveguide display. In particular embodiments, the waveguide configuration 2300B may include a projector device 2350 coupled to a waveguide 2342. The projector device 2320 may include a number of light emitters 2352 (e.g., monochromatic emitters) secured to a support structure 2354 (e.g., a printed circuit board or other suitable support structure). The waveguide 2342 may be separated from the projector device 2350 by an air gap having a distance of DI (e.g., approximately 50 μm to approximately 2500 μm). The monochromatic images projected by the projector device 2350 may pass through the air gap toward the waveguide 2342. The waveguide 2342 may be formed from a glass or plastic material. The waveguide 2342 may include a coupling area 2330 including a number of coupling elements 2334A-C for receiving the emitted light from the projector device 2350. The waveguide 2342 may include a decoupling area with a number of decoupling elements 2336A on the top surface 2318A and a number of decoupling elements 2336B on the bottom surface 2318B. The area within the waveguide 2342 in between the decoupling elements 2336A and 2336B may be referred as a propagation area 2310, in which image light received from the projector device 2350 and coupled into the waveguide 2342 by the coupling element 2334 may propagate laterally within the waveguide 2342.

The coupling area 2330 may include coupling elements (e.g., 2334A, 2334B, 2334C) configured and dimensioned to couple light of predetermined wavelengths (e.g., red, green, blue). When a white light emitter array is included in the projector device 2350, the portion of the white light that falls in the predetermined wavelengths may be coupled by each of the coupling elements 2334A-C. In particular embodiments, the coupling elements 2334A-B may be gratings (e.g., Bragg gratings) dimensioned to couple a predetermined wavelength of light. In particular embodiments, the gratings of each coupling element may exhibit a separation distance between gratings associated with the predetermined wavelength of light and each coupling element may have different grating separation distances. Accordingly, each coupling element (e.g., 2334A-C) may couple a limited portion of the white light from the white light emitter array of the projector device 2350 if white light emitter array is included in the projector device 2350. In particular embodiments, each coupling element (e.g., 2334A-C) may have the same grating separation distance. In particular embodiments, the coupling elements 2334A-C may be or include a multiplexed coupler.

As illustrated in FIG. 10B, a red image 2320A, a blue image 2320B, and a green image 2320C may be coupled by the coupling elements 2334A, 2334B, 2334C, respectively, into the propagation area 2310 and may begin to traverse laterally within the waveguide 2342. A portion of the light may be projected out of the waveguide 2342 after the light contacts the decoupling element 2336A for one-dimensional pupil replication, and after the light contacts both the decoupling elements 2336A and 2336B for two-dimensional pupil replication. In two-dimensional pupil replication, the light may be projected out of the waveguide 2342 at locations where the pattern of the decoupling element 2336A intersects the pattern of the decoupling element 2336B. The portion of the light that is not projected out of the waveguide 2342 by the decoupling element 2336A may be reflected off the decoupling element 2336B. The decoupling element 2336B may reflect all incident light back toward the decoupling element 2336A. Accordingly, the waveguide 2342 may combine the red image 2320A, the blue image 2320B, and the green image 2320C into a polychromatic image instance which may be referred as a pupil replication 2322. The polychromatic pupil replication 2322 may be projected to the user's eyes which may interpret the pupil replication 2322 as a full color image (e.g., an image including colors addition to red, green, and blue). The waveguide 2342 may produce tens or hundreds of pupil replication 2322 or may produce a single replication 2322.

In particular embodiments, the AR/VR system may use scanning waveguide displays or 2D micro-LED displays for displaying AR/VR content to users. In order to miniaturize the AR/VR system, the display system may need to miniaturize the space for pixel circuits and may have limited number of available bits for the display. The number of available bits in a display may limit the display's color depth or gray scale level, and consequently limit the quality of the displayed images. Furthermore, the waveguide displays used for AR/VR systems may have nonuniformity problem cross all display pixels. The compensation operations for pixel nonuniformity may result in loss on image grayscale and further reduce the quality of the displayed images. For example, a waveguide display with 8-bit pixels (i.e., 2256 gray level) may equivalently have 6-bit pixels (i.e., 64 gray level) after compensation of the nonuniformity (e.g., 8:1 waveguide nonuniformity, 0.1% dead micro-LED pixel, and 20% micro-LED intensity nonuniformity).

In particular embodiments, AR/VR systems may include uLEDs display for emitting light and waveguide for coupling light to user's eyes. To display an image, the system may consider the display gamut and the waveguide gamut at each pixel location (i,j). The system may compute a simple gamut mapping operation at each pixel location. In general, the waveguide gamut may have smaller ranges compared to the display gamut. As such, at each pixel location, the color gamut may be defined by the waveguide transmission W(i,j) at that pixel location. If a desired image pixel value P_{i,j} lies within the waveguide color gamut at the location (i,j), that pixel can be rendered directly by the display. However, if the desired image pixel Pᵢⱼ falls outside the color gamut at the pixel location (i,j), the system may not be able to directly displayed, because it does not falls within the color gamut.

To solve this problem, particular embodiments of the system may perform an operation to map the pixel value to the available gamut. This process may be referred to as “projection.” The system may perform a projection along a line from the desired pixel value (which is out-of-gamut) to some point on the neutral axis that is inside the color gamut. The desired pixel value may be projected along the projection line until it intersects with the waveguide color gamut surface or hull. The system may use the intersection point of the projection line and the waveguide color gamut hall as the output pixel value to represent the desired pixel value (also referred to as “target pixel value”). By using the color point corresponding to the intersection point to determine the output pixel value, the system may maximize the saturation level while at the same time preserve the hue (because the projection is along a constant hue angle). This may allow the system to render perceptually optimal waveguide-corrected content, regardless of the dynamic non-uniformity correction (DUC) ratio. The projection of an out-of-gamut target pixel value may be along a line of constant hue onto a value on the gamut hull. The gamut may be defined in XYZ tristimulus space.

This approach may work well to preserve hue, but because the target pixel value is projected along a line of constant hue and then clipped to the gamut surface, the system may lose some image details in the displayed images. This may be particularly severe for achromatic colors, because all out-of-gamut points may end up being projected onto the same location on the color gamut hull. For example, in the areas where the waveguide has greater nonuniformity and consequently the gamut is smaller, the displayed images may lose more image details.

To further improve the qualify of the displayed images, particular embodiments of the system may first scale the luminance of the target pixel value before projecting it back to the color gamut. Assuming a pixel that needs to be displayed, which by definition may fall inside the display gamut but may fall outside the waveguide gamut because the display gamut may be much larger than the waveguide gamut. The system may first convert the target pixel value of the image to a luminance-chrominance space (e.g., the opponent color space). Then, the system may scale the target pixel value to the lightness range allowed by the display and waveguide at that color hue and saturation. Next, the system may perform a projection along a line from the point corresponding to the scaled target pixel value to the black point of the color gamut. The projection line may intersect with the gamut hull and the system may use the color point corresponding to the intersection point to determine the output pixel value to the display to represent the target pixel value. By scaling the luminance before the projection, the system may ensure that the color hue is maintained and may eliminate loses of the image details caused by the clipping issues. As a result, the displayed image may have the correct color hue cross the while image but may have a spatial lightness variation that corresponds to the waveguide transmission.

In particular embodiments, the system may use the gamut-mapping technique as described in this disclosure and enable operations at a dynamic uniformity correction (DUC) ratio of 1 while maintaining optimal image quality. The gamut-mapping technique may allow the system to have large power saving up to 70 mW compared to a DUC ratio of 5, because the uLEDs are driven at a more favorable operating point. Furthermore, the gamut-mapping technique may improve the stability and image quality of displayed images. The system my use a projection operator and a lightness scaling, which eliminates the tendency of the traditional approaches that cause a loss of details. In particular embodiments, the gamut-mapping technique may allow the system to render perceptually optimal waveguide-corrected content, regardless of the DUC ratio.

In particular embodiments, the AR/VR headsets may include μLED display for emitting light and waveguides to couple the light into the user's eyes. However, the waveguides may have color non-uniformity when transmitting light. In other words, the output light of the waveguides may have shifted color spectrum comparing to the input light. As such, the system may use correction maps to correct the waveguide non-uniformity. Each correction map may include an array of scaling factors than can be used to modify the input pixel values of the target image to compensate the waveguide color non-uniformity. In particular embodiments, the color non-uniformity of the waveguide (WG) may be captured in a WG transmittance map, which can be determined based on the WG spectral measurement. For each pixel location, the system may convert the WG spectral measurement to a tristimulus space (XYZ) to determine the WG transmittance map:

$$W = [ \begin{matrix}{X}_{R} & {X}_{G} & {X}_{B} \\ {Y}_{R} & {Y}_{G} & {Y}_{G} \\ {Z}_{R} & {Z}_{G} & {Z}_{G}\end{matrix} ] \qquad ( 1 )$$

where, W is the WG transmittance map, XR, XG, XB, are the RGB components of the X component in the tristimulus space, YR, YG, YB, are the RGB components of the Y component in the tristimulus space, ZR, ZG, ZB, are the RGB components of the Z component in the tristimulus space.

To correct the WG color uniformity, the system may identify a white point target (e.g., D65 white point) in the tristimulus space:

$$w p = [ \begin{matrix}{X}_{D 65} \\ {Y}_{D 65} \\ {Z}_{D 65}\end{matrix} ] = [ \begin{matrix}0.95 \\ 1 \\ 1.08\end{matrix} ] \qquad ( 2 )$$

where, wp represents the white point in the tristimulus space, XD₆₅, YD₆₅, ZD₆₅ represents the X, Y, Z components of the D65 white point. The goal is to derive a map of correction coefficients (scalers) to allow for white balancing at each pixel. It is notable that the same white point can be used for all pixels, to maintain the post-correction luminance across the field of view. Typically, the Y channel in tristimulus space may correspond to the luminance. The relationship between the WG transmittance map W and the correction coefficients t_{R, G, B} can be described as following:

$$[ \begin{matrix}{X}_{R} & {X}_{G} & {X}_{B} \\ {Y}_{R} & {Y}_{G} & {Y}_{G} \\ {Z}_{R} & {Z}_{G} & {Z}_{G}\end{matrix} ] [ \begin{matrix}{t}_{R} \\ {t}_{G} \\ {t}_{B}\end{matrix} ] = [ \begin{matrix}{X}_{D 65} \\ {Y}_{D 65} \\ {Z}_{D 65}\end{matrix} ] = [ \begin{matrix}0.95 \\ 1 \\ 1.08\end{matrix} ] \qquad ( 3 )$$

The above Equation (3) can be represented as following:

$$\begin{matrix}W & t = wp\end{matrix} \qquad ( 4 )$$

Thus, the correction coefficients (t) can be derived by:

$$\begin{matrix}t = {W}^{- 1} & wp\end{matrix} \qquad ( 5 )$$

where the correction coefficients t (scalers) can be applied to each pixel of the target image in the RGB space.

In particular embodiments, the system may need to apply clipping to the correction maps (t) to ensure sufficient display luminance under achievable uLED peak power. The clipping may be described by the clip ratio corresponding to a ratio of the maximum scale value (correction coefficient in the correction map) with respect to the minimum scale value. For example, for a clip ratio=5, the maximum scale value may be limited to 5 times of the minimum scale value. Any scale values that are higher than the 5 times scale value may be “clipped” to the maximum scale value. In other words, the system may enforce the following limits on the maximum scale value within the field of view:

$$max ( {t}_{R}^{′} ) = 5 \times min ( {t}_{R} ) \qquad ( 6 )$$

$$max ( {t}_{G}^{′} ) = 5 \times min ( {t}_{G} ) \qquad ( 7 )$$

$$max ( {t}_{B}^{′} ) = 5 \times min ( {t}_{B} ) \qquad ( 8 )$$

The clipped correction map t′ may be described by the following equation:

$${t}^{′} = [ \begin{matrix}{t}_{R}^{′} \\ {t}_{G}^{′} \\ {t}_{B}^{′}\end{matrix} ] \qquad ( 9 )$$

In particular embodiments, the system may determine the clipped correction maps during an offline computation process. Once the clipped correction map (t′) is determined during the offline process, the system may pre-store this correction map in a computer storage for later usage at runtime.

When rendering an image in the display pipeline, the system may scale the input image (typically in RGB space) based on the correction coefficients (at the corresponding pixel) to compensate the WG color non-uniformity and achieve white balanced output. The output pixel values may be described as following:

$$[ \begin{matrix}{output}_{R} \\ {output}_{G} \\ {output}_{B}\end{matrix} ] = [ \begin{matrix}{input}_{R} & & \\ & {input}_{G} & \\ & & {input}_{B}\end{matrix} ] [ \begin{matrix}{t}_{R}^{′} \\ {t}_{G}^{′} \\ {t}_{B}^{′}\end{matrix} ] \qquad ( 10 )$$

where, output_{R}, output_{G}, and outputs represent the RGB components of the output pixel values; input_{R}, input_{G}, and input represent the RGB components of the input pixel values of the target image pixel, t_{R}′, t_{G}′, and t_{B}′ represent the clipped correction coefficients for that pixel. Such correction operation may be performed for each pixel of the target image (pixel by pixel). The WG color non-uniformity may be compensated. However, because of the clipping operations on the correction coefficients, residual color errors may occur near the periphery area. This is because clipping the correction coefficients may result in a spatially-varying color gamut. The lower the clip ratio, the worse the residual color errors could be. However, a lower clip ratio may also indicate a more relaxed power requirement (require lower μLED instant driving power).

As described earlier, the clipping on the correction coefficients may result in a spatially-varying color gamut at different pixel locations over the field of view (FoV). Because each pixel location of the display may have a different color gamut specific to that pixel location, the system may adjust the target pixel value for each pixel based on the corresponding color gamut to achieve the optimal display results. In particular embodiments, the system may first pre-determine and pre-store WG transmittance map in the tristimulus space (W) in a computer readable storage media. Also, the system may pre-compute the clipped correction maps (t′) for the waveguide color non-uniformity. It is notable that, in particular embodiments, the system may compute the clipped correction map at run time (i.e., on-the-fly). Based on the pre-determined WG transmittance map (W) and the clipped correction map (t′), the system may compute the color gamut allowed by the WG for each pixel location by:

$${W}^{′} = W [ \begin{matrix}{t}_{R}^{′} & & \\ & {t}_{G}^{′} & \\ & & {t}_{B}^{′}\end{matrix} ] = [ \begin{matrix}{X}_{R} {t}_{R}^{′} & {X}_{G} {t}_{G}^{′} & {X}_{B} {t}_{B}^{′} \\ {Y}_{R} {t}_{R}^{′} & {Y}_{G} {t}_{G}^{′} & {Y}_{G} {t}_{B}^{′} \\ {Z}_{R} {t}_{R}^{′} & {Z}_{G} {t}_{G}^{′} & {Z}_{G} {t}_{B}^{′}\end{matrix} ] \qquad ( 11 )$$

where, W′ is the color gamut allowed by WG for that particular pixel location, W is the WG transmittance map, t_{R}′, t_{G}′, t_{B}′ represent the RGB components of the clipped correction coefficients for that pixel location. The color gamut allowed by the WG at each pixel location may correspond to the WG transmittance map as modified by the clipped correction map. Then, the system may compute the max luminance available (maxLum) at a given pixel location by:

$$\begin{matrix}sclr = {W}^{′ - 1} & wp\end{matrix} \qquad ( 12 )$$

$$max Lum = max ( s c l r ) \qquad ( 13 )$$

where sclr is the scaling values (also referred to as scalers) corresponding to correction coefficients that can compensate the WG color gamut to white point, maxLum is the maximum sclr value corresponding to the maximum luminance available at the pixel location. It is notable that, in particular embodiments, both W′ and maxLum may be pre-computed and pre-stored in a computer storage media during an offline computation process.

When displaying an image, the system may, during an online computation process, first convert the input image from RGB color space to the tristimulus space based on uLED's spectral range. Then, the system may perform luminance scaling to make sure the output pixel for each pixel will fall within the color gamut range at that pixel location. The luminance scaling may be performed by:

$${P}_{L S} = P / max Lum = [ \begin{matrix}{X}_{i m} \\ {Y}_{i m} \\ {Z}_{i m}\end{matrix} ] / max Lum \qquad ( 14 )$$

where P_{LS} is the pixel values with the luminance scaled by the maximum luminance, P is the pixel values before the luminance scaling, maxLum is the maximum luminance. By dividing the pixel values by the maximum luminance, the system may have pixel values that are guaranteed to fall within the displayable luminance range of the color gamut. However, it is notable that, by scaling luminance, the luminance of output color may be different from the original luminance of the target pixel values.

After the luminance of the pixel color has been scaled into the color gamut range, the system may perform uniformity correction based on gamut mapping. Assuming at a pixel location (i,j), the target image pixel value is expressed by P₁=P(i,j), the system may first determine whether the pixel color falls within the color gamut at the pixel location. If P₁ falls inside the color gamut of this pixel, that may indicate that the display system is able to display this pixel color and the system may not need to perform the projection as described later for the situation where the target color falls beyond the color gamut at that pixel location. To accurately display the target color P₁, the system may need to ensure the following conditions are met:

$$[ \begin{matrix}{X}_{R} & {X}_{G} & {X}_{B} \\ {Y}_{R} & {Y}_{G} & {Y}_{G} \\ {Z}_{R} & {Z}_{G} & {Z}_{G}\end{matrix} ] [ \begin{matrix}{t}_{R , im} \\ {t}_{G , im} \\ {t}_{B , im}\end{matrix} ] = [ \begin{matrix}{X}_{i m} \\ {Y}_{i m} \\ {Z}_{i m}\end{matrix} ] \qquad ( 15 )$$

$$or$$

$$\begin{matrix}W & {t}_{n e w} = {P}_{1}\end{matrix} \qquad ( 16 )$$

where, W is the WG transmittance map, t_{new} is the output color that can result in the target image pixel value P₁ through the WG with the WG transmittance map W. The output color that can best represent the target color may be determined as following:

$$output = {t}_{n e w} = {W}^{- 1} {P}_{1} \qquad ( 17 )$$

As such, the output pixel value of the corrected image may be directly obtained by multiplication with 3×3 matrix.

In particular embodiments, if the color point of the target pixel value P₁ (after luminance scaling) falls outside the color gamut of this pixel location, the system may need to project the color point back to the color gamut. The system may project along a line of constant hue until the projection line hits the gamut hull then multiply the new pixel value by the 3×3 matrix to compute output pixel value. For example, in the opponent color space, the projection line may pass through the color point of the target pixel value position and extend toward the neutral line (the white-black axis) of the opponent color space. The hue along the projection may be the same (but with different saturation levels). The system may determine the color point of the output pixel value based on the intersection of the projection line with the gamut hull and use the pixel value corresponding to that intersection point as the output pixel value to represent the target pixel value.

In particular embodiments, the system may first convert the color of the target pixel value P₁ to the opponent color space. The opponent color space may have luminance and chrominance dimensions corresponding to the luminance and chrominance channels, respectively. The neutral line may correspond to the luminance axis (e.g., the white-black axis). A line that starts from any point off the neutral line points to a point on the luminance axis that has the same luminance level may have the same hue and luminance but different saturation levels. The system may first determine where the chrominance channel values in the opponent color space. If the chrominance channel values of the color of the target pixel value are zero, the system may determine that it is an achromatic point and may determine a reference color point (P₂) to be black. If any of the chrominance channel values of the color of the target pixel value are greater than zero, the system may determine that this is a chromatic point and may determine a reference color point (P₂) to be a point on the neutral axis having the same luminance level. The reference color point (P₂) for projection may be determined by:

$${P}_{2} = wp * {Y}_{i m} \qquad ( 18 )$$

$$where {Y}_{i m} = {P}_{1} ( 2 ) \qquad ( 19 )$$

The system may use the point corresponding to the color point of the target pixel value P₁ as the starting point and use the reference color point P₂ as the ending point of the projection line to perform the projection. The system may identify a projection direction from P₁ to P₂ based on the locations of these points in the opponent color space. Then, the system may project a ray or line from the color point corresponding to the target pixel value P₁ to the reference color point P₂ on the neutral axis. After that, the system may determine the intersection point of the projection line with the WG gamut hull or surface P₁′ and use the intersection point to determine the output pixel value to the display to represent the target pixel value. Because the projection is along a constant hue, the system may choose P₁′ to be at the WG gamut surface to preserve the saturation of the image to the maximum extent (maximizing saturation while preserving the hue angle). As such, the color of the output pixel value corresponding to the intersection point may have the same color hue with respect to the target pixel value, but may have different saturation level (because of the projection) and different luminance (because of the luminance scaling operation before the projection). The pixel value corresponding to the intersection point of the projection line to the gamut hull P₁′ may be used to determine the output pixel value to represent the target pixel value using the following equations

$$[ \begin{matrix}{X}_{R} & {X}_{G} & {X}_{B} \\ {Y}_{R} & {Y}_{G} & {Y}_{G} \\ {Z}_{R} & {Z}_{G} & {Z}_{G}\end{matrix} ] [ \begin{matrix}{t}_{R , im} \\ {t}_{G , im} \\ {t}_{B , im}\end{matrix} ] = [ \begin{matrix}{X}_{im}^{′} \\ {Y}_{im}^{′} \\ {Z}_{im}^{′}\end{matrix} ] \qquad ( 21 )$$

$$or$$

$$\begin{matrix}W & {t}_{n e w} = {P}_{1} ’\end{matrix} \qquad ( 20 )$$

Thus, the system may determine the output pixel value by multiplication with the 3×3 matrix as following:

$$output = {t}_{n e w} = {W}^{- 1} {P}_{1}^{′} \qquad ( 22 )$$

In this approach, the system may supply input pixel value to the uniformity correction operator and determine the output pixel values (i.e., white balanced output=t_{new}) on the fly. In this approach, the system can achieve a hue-corrected content regardless of the clipping ratio at the expense of spatially varying lightness, which is determined by the WG transmittance characteristic. The system may achieve optimal display results even for the clip ratio=1, which indicates that this approach may provide power saving benefits to the system.

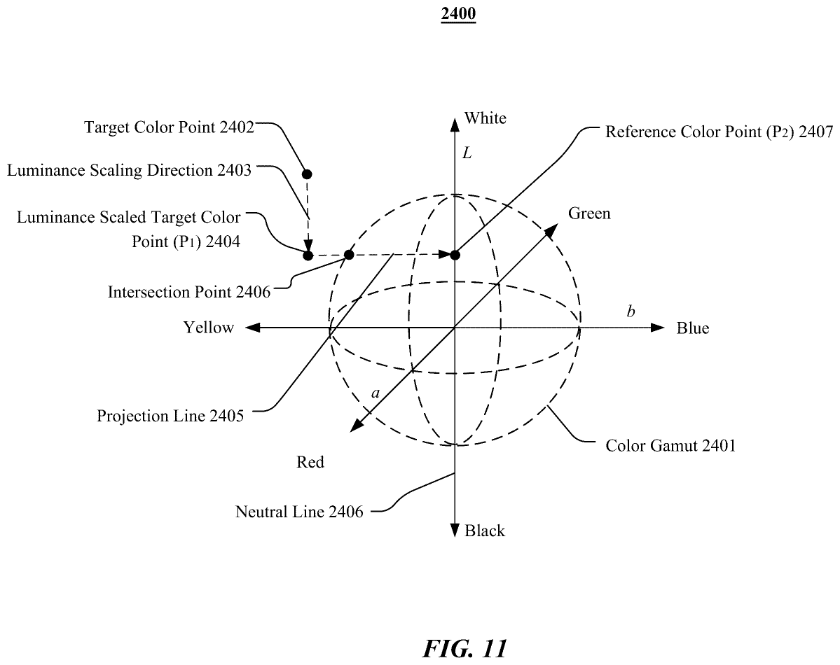

FIG. 11 illustrate example processes 2400 of projecting a target color that is outside of the display color gamut to the display color gamut. As an example and not by way of limitation, the color gamut 2401 may correspond to a waveguide color gamut in an opponent color space (e.g., a Lab color space) at a particular pixel location. For the pixel, the target image may have a particular target pixel value. The system may first determine the target color point 2402 based on the target pixel value. The system may determine that target color point 2402 is beyond the color gamut 2401 and may need to be projected back to the color gamut 2401. It is notable that the target color point 2402 may also be beyond the luminance range of the color gamut 2401. For some pixels, their target color points (not shown) may be within the luminance range of the color gamut 2401 even though these color points may fall outside the color gamut 2401. The system may first scale the luminance of the target color point 2402 along a luminance scaling direction that is parallel to the neural line 2406 (the luminance axis) using Equation 14 as described earlier. After the scaling operation, the luminance level of the target color point 2402 may be within the luminance range of the color gamut 2401 (this will be true regardless of whether the target color point 2402 was originally beyond the luminance range of the color gamut 2401). The luminance scaled target color 2404 may correspond to the starting point of the projection (P₁). Then, the system may determine a reference color point (P₂) 2407 on the neutral line 2406 having the same luminance level with respect to the luminance scaled target color 2404. After that, the system may determine the projection line 2406 which may start from the luminance scaled target color point (P₁) 2404 to the reference color point (P₂). The color points along the projection line 2405 may have the same color hue but different saturation values and the projection line 2405 may be a constant hue line. The system may use the projection process to determine the intersection point 2406 of the projection line 2405 with the hull of the color gamut 2401. The intersection point 2406 may be used as the color point for determining the output pixel value to represent the target pixel value. As such, the output pixel value as determined based on the intersection point 2406 may have the same color hue with the target color point 2402 and may have the maximumly possible saturation for the given color gamut 2401 (because the color point 2402 is on the hull of the color gamut 2401.

In particular embodiments, the system may use correction coefficients to compensate for distortions caused by the waveguide. For the target pixel values' color points that are projected back to the color gamut, the system may perform the WG color non-uniformity correction after the projection operations. If the color point of the target pixel value falls within the gamut, the system would compensate the WG nonuniformity based on output=W⁻¹ p, wherein W⁻¹ can be implemented by 3×3 matrix. If the color point of the target pixel value falls outside the gamut, the system may replace the target pixel value P₁ with the pixel value corresponding to the intersection between projection line along a constant hue and the gamut hull P₁′, and then apply the WG non-uniformity corrections by: output=t_{new}=W⁻¹ P₁′. In particular embodiments, the system may first determine whether the color point of the target pixel value is inside or outside gamut before the WG uniformity correction. The system may directly take the target pixel value, feed it to gamut mapper/correction operator, then determine the output pixel values accordingly. As a result, the system may be able to ensure hue accuracy but allow the displayed image to have spatially-varying luminance.

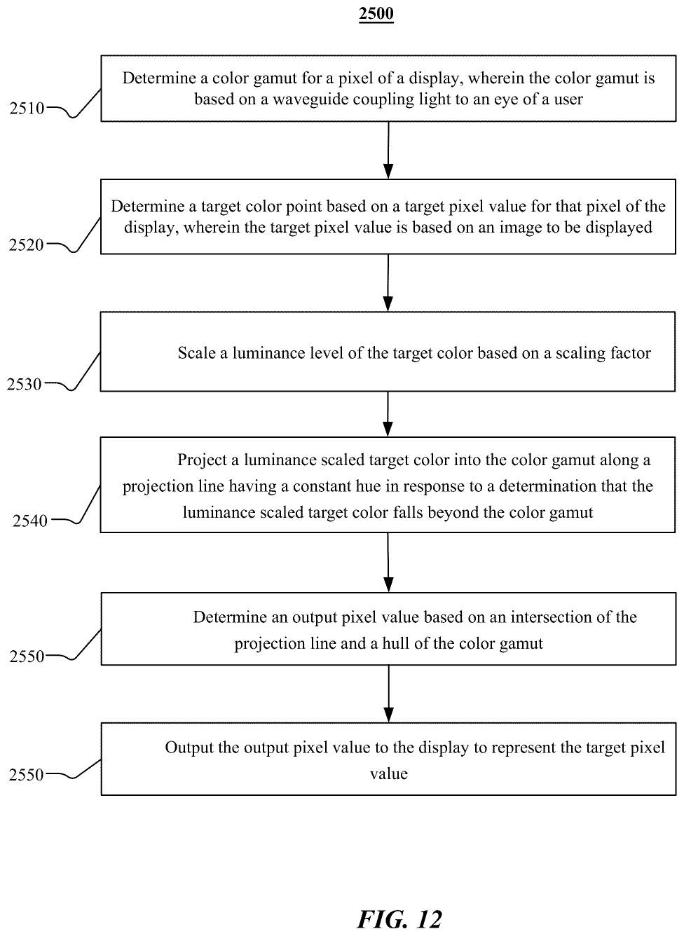

FIG. 12 illustrate example processes 2500 of determining an output pixel value by projecting a target color that is outside the display color gamut to the display color gamut after scaling the luminance level. The method may begin at step 2510, wherein a computing system may determine a color gamut for a pixel of a display, wherein the color gamut is based on a waveguide coupling light to an eye of a user. At step 2520, the system may determine a target color point based on a target pixel value for that pixel of the display, wherein the target pixel value is based on an image to be displayed. At step 2530, the system may scale a luminance level of the target color based on a scaling factor. At step 2540, the system may project a luminance scaled target color into the color gamut along a projection line having a constant hue in response to a determination that the luminance scaled target color falls beyond the color gamut. At step 2550, the system may determine an output pixel value based on an intersection of the projection line and a hull of the color gamut. At step 2550, the system may output the output pixel value to the display to represent the target pixel value.

Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for determining an output pixel value by projecting a target color that is outside the display color gamut to the display color gamut after scaling the luminance level including the particular steps of the method of FIG. 12, this disclosure contemplates any suitable method for determining an output pixel value by projecting a target color that is outside the display color gamut to the display color gamut after scaling the luminance level including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

For AR systems, AR imageries are mostly sparse. When LCD is used to display AR images, most of the backlight is blocked (because no imagery content in these areas) and thus is wasted, resulting in non-optimal power-efficiency. The uLED display can be more efficient because it can only light the pixel areas that have the AR imagery content. However, uLED display technology is not yet mature enough for AR applications. Furthermore, AR displays need to have a higher contrast than normal display (e.g., display for TVs) because the AR content is displayed over the real-world background scene, which could be very bright. To achieve a higher contrast, the display needs to drive the uLED or LCD with higher power, that will increase the power consumption of the AR system.

To solve these problems, particular embodiments may use a phase-modulating display module (liquid-crystal display) as a light source to provide zonal backlight for an amplitude-modulating display module to display AR images. The light source for the even backlight of the amplitude-modulating display module may be replaced by a phase-modulating display module. The phase-modulating display module may serve as a 2D zonal backlight source with steerable backlight for the amplitude-modulating display module. The phase-modulating display module may have a laser light source as its own backlight source, which can have low-power consumption and can be very efficient. The phase-modulating display module may modulate the phase front of the incident light and steer the light beams along any directions to target pixel areas. In other words, the phase-modulating display module may arbitrarily steer the incident light beams to any directions as needed. As such, the display system may use the phase-modulating display module to steer the light beams from the laser light source to the amplitude-modulating display module's pixel areas that have imagery content. As a result, the light from the laser light source of the phase-modulating display module may be focused on the pixel areas that have imagery content (rather than having a large portion being wasted as in the traditional amplitude-modulating display module). In other words, the light beams that are originally directed to (i.e., without steering) the pixel areas having no imagery content may be steered to the pixel areas that have imager content, rather than being wasted as in the amplitude-modulating display module with non-steerable light source. Using this approach, the AR display system may achieve high power efficiency (with less wasted light) and higher brightness (e.g., light concentrated to the image content areas), despite the sparse nature of AR imagery.

To display an AR image, the display system may first determine a pattern corresponding to pixel areas that contain the AR imagery content. The pattern may include a number of zones where each zone may include an array of display pixels of the amplitude-modulating display module, corresponding to a block of pixel area of the amplitude-modulating display module. The display system may use a pre-determined zone size which is optimized to maximum the efficient and brightness of the display. Then, the phase-modulating display module may steer the light beams from the laser light source to these zones according to the pattern, rather than lighting up the whole display panel evenly like the traditional LCD. In other words, the phase-modulating display module may steer the light beams that originally would be directed to the pixel areas having no imagery content to the pixels areas that have imagery content. The lighted pattern may serve as the backlight for the amplitude-modulating display module. The backlight provided by the lighted pattern generated by the phase-modulating display module may be polarized in the S direction and may be projected to the split lens. The split lens may reflect these light beams polarized in the S direction to the pixel plane of the amplitude-modulating display module to provide backlight for the pixels of the amplitude-modulating display module according to the pattern including a number of zones.

The laser source of the phase-modulating display module may emit light with a particular color of the RGB colors. As described above, the phase-modulating display module may steer the light beams emitted by the laser source in the particular color to the split lens, which may reflect these light beams to the pixel plane of the amplitude-modulating display module according to the pattern including the corresponding zones. The lighted pattern which includes a number of zones may serve as the light source the backlight of the amplitude-modulating display module. The display pixels in each zone may be lighted to a same base target color, which may correspond to an average pixel color of that particular color channel of the image pixels corresponding to that zone area. The amplitude-modulating display module may control its display pixels to attenuate/absorb the incident light according to the corresponding target pixel values, and reflect the light back to the split lens. In other words, the amplitude of the light intensity may be modulated in a per pixel manner to achieve the target grayscale values. The light that is reflected by the amplitude-modulating display module may be projected to the split lens and may be polarized in the P direction. As a result, the reflected light may pass through the split lens to reach the viewer's eye.

The laser source may emit light in RGB colors sequentially in time. For each zone of the pattern to be lighted up, the display system may determine a target base color for each color channel, which could be the average target pixel color for the display pixels in that zone (per color channel), and the zone may be lighted to that target base color for that color channel. Then, the backlight of these zones may be attenuated/modulated by the amplitude-modulating display module in a per pixel manner to according to the corresponding target grayscale values to display the image. The display system may work sequentially in time to display three images corresponding to the RGB color channel, sequentially in time, which will cause the human eyes to perceive as a whole picture. As a result, the AR image may be displayed with a greater brightness while the display system consumes much less power.

In particular embodiments, the amplitude-modulating display module or amplitude-modulating display module as described in this disclosure may be a small-pixel ferroelectric (FLCOS) modulator with bistable FLC (ferroelectric liquid crystal) mixtures and CMOS backplanes. In particular embodiments, the phase-modulating display module or phase-modulating display module may be a phase-modulating LCOS device, acting as a steerable 2D backlight source. Because of the sparse nature of AR imagery, the efficiency of amplitude-modulating displays may be fundamentally compromised because a large portion of the image is black and the backlight for that portion becomes wasted. A 2D LED backlight could be used to improve efficiency by illuminating the panel only in regions where the pixels are on. However, uLED may not provide sufficient brightness and may also other problems. Using the phase-modulating display module as the 2D steerable zonal backlight source may address both brightness and efficiency concerns. The phase-modulating display module may be capable of arbitrarily steering incident light to the pixel areas that have imagery content to display, providing a higher peak brightness and minimizing light lost at the amplitude modulator. Furthermore, the laser-based source for the phase-modulating display module may be very efficient in power consumption. FLCOS displays with CMOS backplanes may consume very little power comparing to other display technologies. The phase-modulating LCOS device may use a nematic material which can provide phase level greater than 16 phase levels. In particular embodiments, to further improve the efficiency, the amplitude-modulating display module may be as transmissive as possible to reduce optical loss (e.g., the transmissive rate being higher than a pre-determined threshold).

Traditionally, an amplitude-modulating display module display may have an even light source which provides even backlights for all pixels. The light emitted by the light source may be polarized in two directions of S and P. The polarized light may be projected to a split lens which is positioned at 45-degree angle to the light source plane. The split lens may allow the light polarized in the P direction to pass (and thus cause this portion of light to be wasted), but may reflect the light polarized in the S direction to the amplitude-modulating display module plane. Each pixel of the amplitude-modulating display module may be controlled to be “turned on” to allow at least some light to pass and reflected or “turned off” to absorb the incident light. If the pixel is “turned off”, all the incident light at that pixel location may be absorbed and no light may be reflected to the user's eye. When a pixel is “turned on,” the LCD pixel at that location may be controlled to allow at least a portion of the light to pass. The liquid crystal at that location may be controlled to absorb the incident light (and thus reduce the light intensity amplitude) at that pixel location according to the target grayscale value for that pixel. As such, the light that passes through the liquid crystal at that pixel location may have been attenuated by the amplitude-modulating display module in a per pixel manner according to the target grayscale value of that pixel. The light beams that are reflected by the amplitude-modulating display module may be reflected by a back panel which serves as a ¼ wavelength plate for phase shifting and reflects the incident light along the opposite of the incident direction with a phase shift. The incident light polarized in the S direction may be shifted in phase and polarized in the P direction after being reflected. When the reflected light beams polarized in the P direction hit the split lens, the spit lens may allow the light beams to pass through it to reach the viewer's eye.

To display a color image, the light source may emit light in RGB colors sequentially in time and the amplitude-modulating display may control its pixels to reflect/absorb the incident light of different color channel sequentially in time to display the image. The backlight source may evenly light up all the pixels of the display panel. For the areas that have no imagery content, the backlight may be blocked (e.g., absorbed) by the LCD and thus become wasted. Because of the sparse nature of AR imagery, a large portion of the backlight power may be wasted. Furthermore, because of the light of each color channel is attenuated to achieve the target grayscale and the light is split by the split lens, the overall brightness of the displayed image on the LCD display may be very limited. As such, the amplitude-modulating display module may be inefficient in power consumption. To achieve sufficient brightness, the light source for the backlight may need to use more power to provide higher light intensities. In particular embodiments, the display may use a phase-modulating display module (liquid-crystal display) as a light source to provide zonal backlight for an amplitude-modulating display module to display AR images, as described below.

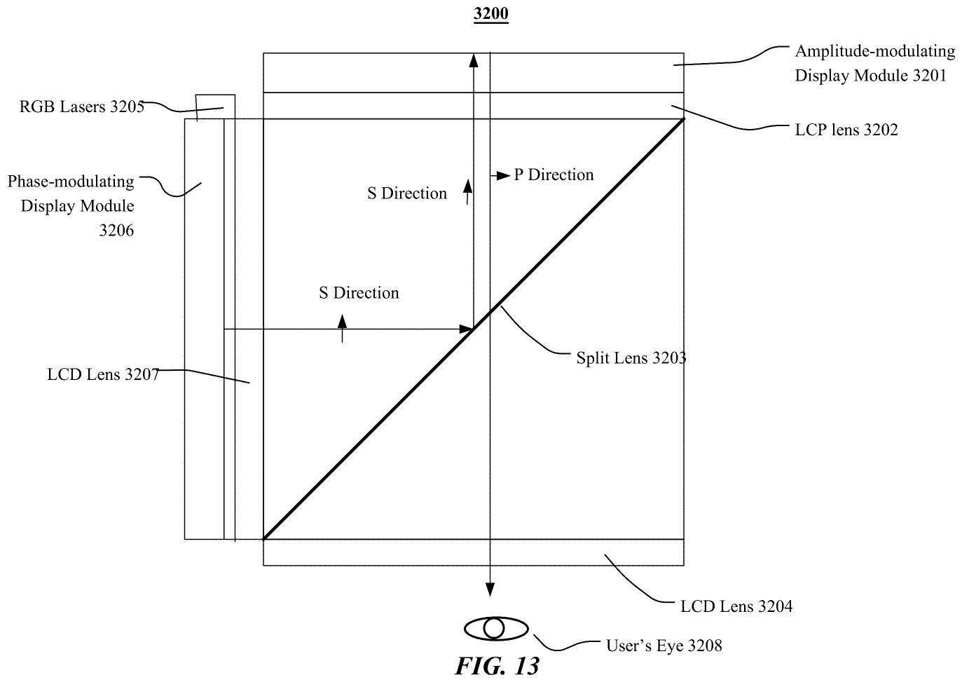

FIG. 13 illustrates an example display 3200 using a phase-modulating display module 3206 as a steerable zonal light source to provide backlight for an amplitude-modulating display module 3201. As an example and not by way of limitation, the display 3200 may include an amplitude-modulating display module 3201, a LCP (lens correction profile) lens 3202, a split lights 3203, a first LCD lens 3204, a phase-modulating display module 3206 (which has RGB lasers 3205 as its light source), a second lens 3207, etc. The phase-modulating display module 3206 may have RGB lasers 3205 as its slight source, which can be very power efficient. The phase-modulating display module 3206 may control the liquid crystal of its pixels to change the phase front of the incident light beams and steer the incident light beams (from the RGB lasers 3205) to any desired direction. In other words, the phase-modulating display module 3206 may be capable of steering the incident light beams to arbitrary directions (e.g., in a per pixel manner). As will be described later, the phase-modulating display module 3206 may not need to have as a high resolution as that of the amplitude-modulating display module 3201 because the basis unit for light steering may corresponding to a zone corresponding to a block of the display pixels of the amplitude-modulating display module. As such, the phase-modulating display module 3206 may have much lower pixel resolution than the amplitude-modulating display module 3201.

In particular embodiments, the phase-modulating display module 3206 may have RGB lasers 3205 as its light source, which may emit light in RGB colors sequentially in time (e.g., light of RGB colors in sequential time windows). During a particular time window, the RGB lasers 3205 may emit light of a particular color of RGB color. The emitted light may be provided to the phase-modulating display module 3206 as backlight. The phase-modulating display module 3206 may modulate the phase of the incident light beams at a per pixel level and steer the incident light beams to particular directions. The phase-modulating display module 3206 may cause the light emitted by the RGB lasers 3205 to pass its liquid crystal and the lens 3207 and to be steered/projected to the split lens 3203. The light from the phase-modulating display module 3206 may be polarized in the S direction. As a result, the split lens 3203 may reflect the light beams from the phase-modulating display module 3206 to the pixel plane of the amplitude-modulating display module 3201. The light beams projected to the pixel plane of the amplitude-modulating display module 3201 may be directed to a pattern which includes a number of zone with each zone correspond to a block display pixels of the amplitude-modulated LCD 3201.

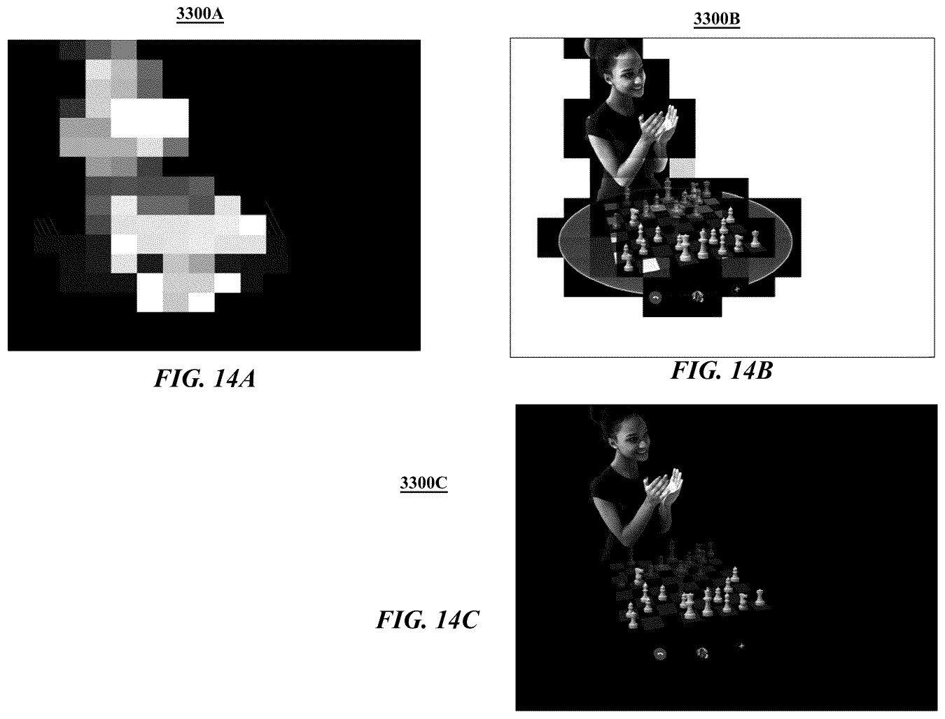

FIG. 14A illustrates an example pattern 3300A corresponding imagery content areas including a number of zones. In particular embodiment, the display 3200 may first determine (e.g., using one or more associated processors) a pattern on the pixel plane of the amplitude-modulating display module 3201 based on the AR imagery content to be displayed. An example pattern is shown in FIG. 14A. The pattern on the pixel plane of the amplitude-modulating display module 3201 may correspond to display areas that contain the imagery content of the AR image to be displayed. The pattern may include a number of zones with each zone corresponding to a block of display pixels or an array of the display pixels of the amplitude-modulating display module 3201. The light beams that are originally (without steering) directed to the display areas that contain no imagery content may be steered to the display areas (i.e., the pattern) that contain the imagery content. The RGB lasers 3205 of the phase-modulating display module 3206 may emit light with a particular color of the RGB colors. The phase-modulating display module 3206 may steer the light beams emitted by the RGB lasers in the particular color to the split lens 3203. The light from the phase-modulating display module 3206 may be polarized in the S direction. As a result, the split lens 3203 may reflect these light beams to the pixel plane of the amplitude-modulating display module 3201 according to the pattern including the corresponding zones. The lighted pattern which includes a number of zones may serve as the light source the backlight of the amplitude-modulating display module 3201. In particular embodiments, the zone formation may be achieved by calculation of a phase-only hologram pattern which diffracts light into zones as desired.

In particular embodiments, the display pixels in each zone may be lighted to a same base target color, which may correspond to an average pixel color of that particular color channel of the image pixels included in that zone area. The laser source may emit light in RGB colors sequentially in time. The display system may work sequentially in time to display three images corresponding to the RGB color channel, sequentially in time, which will cause the human eyes to perceive as a whole picture. For each zone of the pattern to be lighted up, the display system may determine a target base color for each color channel, which could be the average target pixel color for the display pixels in that zone (per color channel), and the zone may be lighted to that target base color for that color channel. It is notable that, different zones may have different base colors for the backlight depending on the target pixel color of particular zones. However, the light intensity for each zone may be the same. The light intensity here may refer to the overall intensity considering all three base colors of the RGB color channels. In particular embodiments, the display pixel areas of the amplitude-modulating display module may be divided into zone and each zone may be illuminated to the maximum intensity required for that zone. After that, the backlight of these zones may be attenuated/modulated by the amplitude-modulating display module in a per pixel manner to according to the corresponding target grayscale values to display the image.

In particular embodiments, the amplitude-modulating display module 3201 may control its display pixels to attenuate/absorb the incident light according to the corresponding target pixel values, and reflect the light back to the split lens 3203. In other words, the amplitude of the light intensity may be modulated in a per pixel manner to achieve the target grayscale value. The amplitude-modulating display module 3201 may have a ¼ wavelength plate that will shift the incident light phase. As a result, the light that is reflected by the amplitude-modulating display module 3201 may be polarized in the P direction before being projected to the split lens 3203 and. The reflected light may pass through the split lens 3203 and the LCD lens 3204 to reach the viewer's eye 3208.

In particular embodiments, because the light beams may be steered to the display areas of the amplitude-modulating display module 3201 according to the pattern including a number of zones. The steering process may be in a per-zone manner. As such, the phase-modulating display module 3206 may not need to have a as high resolution as that of the amplitude-modulating display module 3201, because the basis unit for light steering may corresponding to a zone corresponding to a block of the display pixels of the amplitude-modulating display module. As such, the phase-modulating display module 3206 may have a lower pixel resolution than the amplitude-modulating display module 3201, depending on the size of the zone. The system may determine the pixel resolution of the phase-modulating display module 3206 based on the size of the zone.

In particular embodiments, the display 3200 may use a pre-determined zone size which is optimized to maximum the efficient and brightness of the display. The phase-modulating display module may steer the light beams from the RGB lasers 3205 to these zones according to the determined pattern, rather than lighting up the whole display panel evenly like the traditional LCD. The lighted pattern may serve as the backlight for the amplitude-modulating display module. The backlight provided by the lighted pattern generated by the phase-modulating display module may be polarized in the S direction and may be projected to the split lens. The split lens may reflect these light beams polarized in the S direction to the pixel plane of the amplitude-modulating display module to provide backlight for the pixels of the amplitude-modulating display module according to the pattern including a number of zones. As such, the light emitted from the RGB laser 3205 may be concentrated in the display areas (e.g., the zones as shown in FIG. 14A) that contain the image content, rather than being wasted. Thus, the display 3200 may have higher power efficiency than the amplitude-modulating display module that use the even backlight source. Furthermore, because the light is concentrated in the areas that have imagery content, the display may achieve a higher brightness without increasing the power consumption.

FIG. 14B illustrates an example AR image content 3300B to be displayed. FIG. 14C illustrates an example AR image 3300C displayed on an amplitude-modulating display 3201 using a phase-modulating display 3206 as a steerable zonal backlight source. As shown in FIG. 14A, the pattern that is lighted by the phase-modulating display module 3206 as a steerable zonal backlight source may include a number of zones. Each zone may cover a block of display pixels. The pattern including the zones may correspond to the display areas that contain the AR image content 3300B. The light from the RGB lasers 3205 may be steered to the zones included in the pattern corresponding to the display areas containing the AR image content 3300B. It is notable that the zones in FIG. 14A, which are shown in black-white image, may actually be lighted to different base colors according to the target pixel value in that zone. The base color of a particular color channel for a zone may correspond to an average pixel color of that color channel of the image pixels fall within that zone. The zones in the pattern may be lighted to the same light intensity. Once the pattern is lighted, it may be provided to the amplitude-modulating display module 3201 as a zonal backlight. The amplitude-modulating display module 3201 may modulate the amplitude of the light of each color channel to achieve the corresponding target grayscale values. The display may repeat the process for RGB color channel sequential in time to display three images of RGB color channels. These three images may be displayed sequentially in time within a pre-determined time period that allows the human eye to perceive them as a single image with RGB colors.

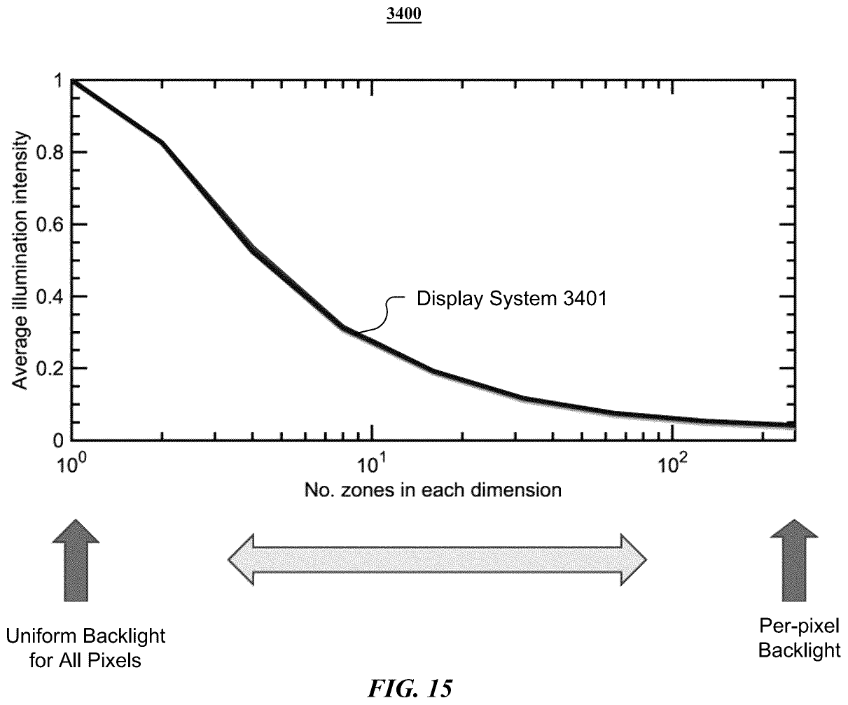

FIG. 15 illustrates an example process 3400 using a performance curve 3401 to determine an optimized zone size. In particular embodiments, the efficacy of this scheme may depend on the number of zones. If the system has only one zone (i.e., a uniform backlight over all pixels), the illumination intensity may be equal to the white point (similar to traditional amplitude-modulating display module using a uniform white backlight). The backlight intensity may need to match the pixel values of the AR image to be displayed. This may consume much power and not efficiency. If the system has the number of zones equal to the number of image pixels (i.e., per-pixel backlight), the system may reduce the required illumination intensity to the image mean (similar to the case of using uLED for backlight source, which allow pixels to be lighted in a per pixel manner). Using the phase-modulating display module as the 2D zonal backlight source, the system may achieve an efficiency in between the above two senecios. The curve 3401 shown in FIG. 15 may show the backlight intensity averaged over a number of AR type use cases, as a function of the number of zones. With 10×10 zones, the system may achieve an average backlight intensity of 20% with respect to the uniform backlight for all pixels. As such, the system may save 20% of power by using the steerable zonal backlight or may be capable of achieving 5 times of higher light intensity, using the amount of power with respect to the solution using the uniform backlight for all pixels.

As an example and not by way of limitation, a display performing at 3100% average pixel value may consume 3400 mW power. Using uLEDs, the waveguide and optical system may result in a peak display brightness of 70 cd/m² (i.e., each and every pixel is capable of 70 cd/m²). For AR-type images, the mean pixel intensity may be about 3% without including any other electrical inefficiencies. As such, the uLEDs solution may consume 12 mW on average. As the mean pixel intensity reduces, the power consumption may also reduce, which makes it a suitable solution for an AR display. Since the system is designed to meet a power consumption specification at 3100% fill, it may not be possible to increase the peak brightness beyond 70 cd/m² without overdriving uLEDs. For the 2D steerable zonal backlight solution, the system may have the same image having up to 3% average pixel value. With 10×10 zones, the average backlight intensity for this solution may be 20% of the solution using uniform backlight for all pixels. As such, the system can increase the display peak brightness by a factor of five, because the light can be steered to the places where it is needed. Power brightness may be a variable for the dual LCOS architecture. For an average pixel intensity less than 3100%, the system may choose to either maintain 3400 mW power consumption and maximize brightness (e.g., maintain the brightness corresponding to 3100% fill, and reduce the power consumption from 3400 mW, or match the brightness that the corresponding uLED display would produce). Dual LCOS solution may be capable of overdrive by default, and may have the potential to deliver >1,3000 cd/m2 for sparse content using current waveguide technology.

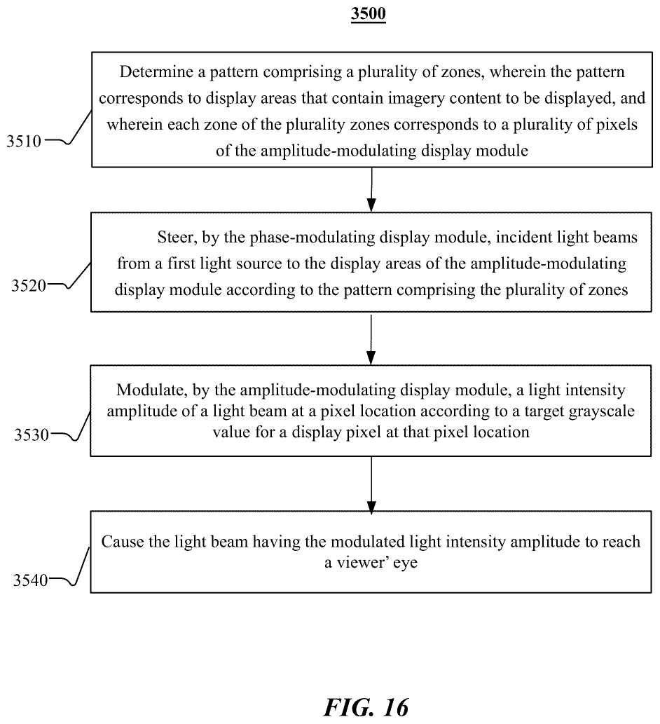

FIG. 16 illustrates an example method 3500 of displaying an AR image using an amplitude-modulating display which uses a phase-modulating display module as a 2D steerable zonal backlight source. The method may begin at step 3510, where an electronic device, having a phase-modulating display module and an amplitude-modulating display module may determine a pattern comprising a number of zones. The pattern may correspond to display areas that contain imagery content to be displayed. Each zone of these zones may correspond to a number of pixels of the amplitude-modulating display module. At step 3520, the electronic device may steer, by the phase-modulating display module, incident light beams from a first light source to the display areas of the amplitude-modulating display module according to the pattern comprising the zones. At step 3530, the electronic device may modulate, by the amplitude-modulating display module, a light intensity amplitude of a light beam at a pixel location according to a target grayscale value for a display pixel at that pixel location. At step 3540, the electronic device may cause the light beam having the modulated light intensity amplitude to reach a viewer's eye.

In particular embodiments, the phase-modulating display module may be a phase-modulating field-sequential panel, and the amplitude-modulating display module may be an amplitude-modulating field-sequential panel. In particular embodiments, the electronic device may be an augmented reality device, and wherein the pattern comprising the plurality of zones may be determined based on a content of an image to be displayed by the augmented reality device over a real-word scene. In particular embodiments, steering incident light beams to the display areas of the amplitude-modulating display module according to the pattern comprising the plurality of zones may comprise: steering one or more first incident light beams initially directed to a first display area of the amplitude-modulating display module to a second display area of the amplitude-modulating display module; and steering one or more second incident light beams to initially directed to the second display area of the amplitude-modulating display module to the second display area of the amplitude-modulating display module.

In particular embodiments, the first display area of the amplitude-modulating display module may be beyond the display areas that contain the imagery content to be displayed, and wherein the second area of the amplitude-modulating display module may contain at least a portion of the imagery content to be displayed. In particular embodiments, the incident light beams may be polarized in a first direction and projected to a split lens, and wherein the split lens may reflect the incident light beams polarized in the first direction to the second area of the amplitude-modulating display module. In particular embodiments, modulating the light intensity amplitude of the light beam at the pixel location according to the target grayscale value for the display pixel at that pixel location may comprise, by the amplitude-modulating display module: generating one or more control signals for the display pixel based on the target grayscale value for the display pixel; applying the one or more control signals to liquid crystal material associated with the display pixel, wherein the liquid crystal material may attenuate the light intensity amplitude of the light beam by absorbing a portion of the light beam based on the one or more control signals.

In particular embodiments, modulating the light intensity amplitude of the light beam at the pixel location according to the target grayscale value for the display pixel at that pixel location may further comprise, by the amplitude-modulating display module: polarizing the light beam at the pixel location in a second direction; and reflecting the light beam at the pixel location polarized in the second direction to a split lens that allow light beams polarized in the second direction to pass.

In particular embodiments, the light source may be a laser light source emitting light in RGB colors sequentially in time, and wherein the light beam having the modulated light intensity amplitude may be associated with a color channel of RGB color channels. In particular embodiments, the incident light beams steered to the display areas of the amplitude-modulating display module may provide backlight for the amplitude-modulating display module. In particular embodiments, the incident light beams steered to the display areas of the amplitude-modulating display module may be un-evenly distributed across the display areas of the amplitude-modulating display module. In particular embodiments, the display areas of the amplitude-modulating display module may be partially lighted up by the incident light beams steered to the display areas of the amplitude-modulating display module. In particular embodiments, the incident light beams steered to the display areas of the amplitude-modulating display module may comprise light beams of RGB colors, and wherein light beams of each color of the RGB colors may be steered to the display areas of the amplitude-modulating display module sequentially in time.

In particular embodiments, each zone of the plurality of zones may comprise a plurality of display pixels of the amplitude-modulating display module, and the plurality of display pixels of that zone may be lighted up by the incident light beams steered to the display areas of the amplitude-modulating display module to a target base color. In particular embodiments, the target base color may be determined based on an average value of a plurality of target pixel values for the plurality of display pixels in that zone. In particular embodiments, the plurality of zones may be lighted up to a target light intensity amplitude. In particular embodiments, the target light intensity amplitude may be determined based on a target brightness level of the amplitude-modulating display module. In particular embodiments, the electronic device may be an augmented reality device configured to display an augmented reality image over a real-world scene, and wherein the augmented reality image to be displayed has a sparse nature.

Particular embodiments may repeat one or more steps of the method of FIG. 3, where appropriate. Although this disclosure describes and illustrates particular steps of the method of FIG. 16 as occurring in a particular order, this disclosure contemplates any suitable steps of the method of FIG. 16 occurring in any suitable order. Moreover, although this disclosure describes and illustrates an example method of displaying an AR image using an amplitude-modulating display which uses a phase-modulating display module as a 2D steerable zonal backlight source including the particular steps of the method of FIG. 16, this disclosure contemplates any suitable method of displaying an AR image using an amplitude-modulating display which uses a phase-modulating display module as a 2D steerable zonal backlight source including any suitable steps, which may include all, some, or none of the steps of the method of FIG. 16 where appropriate. Furthermore, although this disclosure describes and illustrates particular components, devices, or systems carrying out particular steps of the method of FIG. 16, this disclosure contemplates any suitable combinations of any suitable components, devices, or systems carrying out any suitable steps of the method of FIG. 16.

In the realm of computer graphics, 3D graphics are often designed using graphic APIs, such as OpenGL® and Vulkan®. 3D content, such as games, designed using one API may need to be ported into another API to take advantage of certain new features or improvements. For example, applications designed using traditional OpenGL® may need to be ported to Vulkan® to take advantage of its higher performance and control over the GPU/CPU.

Particular embodiments described herein aims to simplify the process of migrating old OpenGL® applications to Vulkan® 1.3, offering a seamless transition by eliminating the need for intricate descriptor set management and customized pipeline layouts making all shaders interchangeable. Particular embodiments described herein emulates the traditional OpenGL® slot-based binding model by using Vulkan's® descriptor indexing functionality. By using Vulkan® 1.3 descriptor indexing features, developers can efficiently avoid the complexities associated with graphics pipelines and descriptor sets manipulation. While this method proves advantageous for rapid prototyping and the porting of older OpenGL® projects, it's worth noting its potential performance limitations on outdated hardware. Nonetheless, this approach presents a pragmatic pathway for developers aiming to use descriptor indexing capabilities while porting their existing OpenGL® applications to Vulkan®.

The Intermediate Graphics Library (IGL) has a cross-platform umbrella API which abstracts away different version of OpenGL. An API may allow the binding of buffers, textures, and centers individually to specific binding slots, similar to how gen binds texture binds the texture to a target. For a developer, accomplishing this would require complicated Vulcan descript asset management code, thereby making rapid prototyping a challenging process. To save time and effort, we can utilize Vulcan bindless species instead of writing descriptive set management code. Bindless in Volcan refers to the support of two extensions: buffer device address (VK_KHR_buffer_device_address) and descriptor indexing (VK_EXT_descriptor_indexing). These extensions have been promoted to the core Vulcan 1.2, and starting from Vulcan 1.3 they are guaranteed to be supported. These extensions may be utilized to efficiently implement the render command encoder interface.

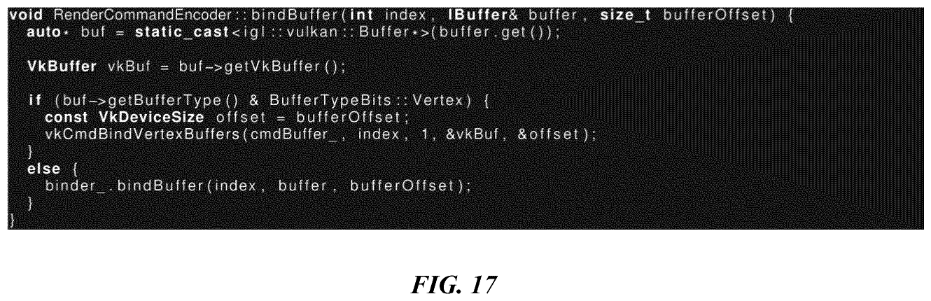

In one example, a C++ implementation is divided into two parts. The high level part implements the functions of the render command and loader class. The low level part interacts with the Vulcan API. FIG. 17 shows an example pseudo code for a bindBuffer function. It is capable of handling all types of buffers, but vertex buffers require special treatment. The handling of other buffers such as shader storage and uniform buffers is done within the low level C++ code through the binder object.

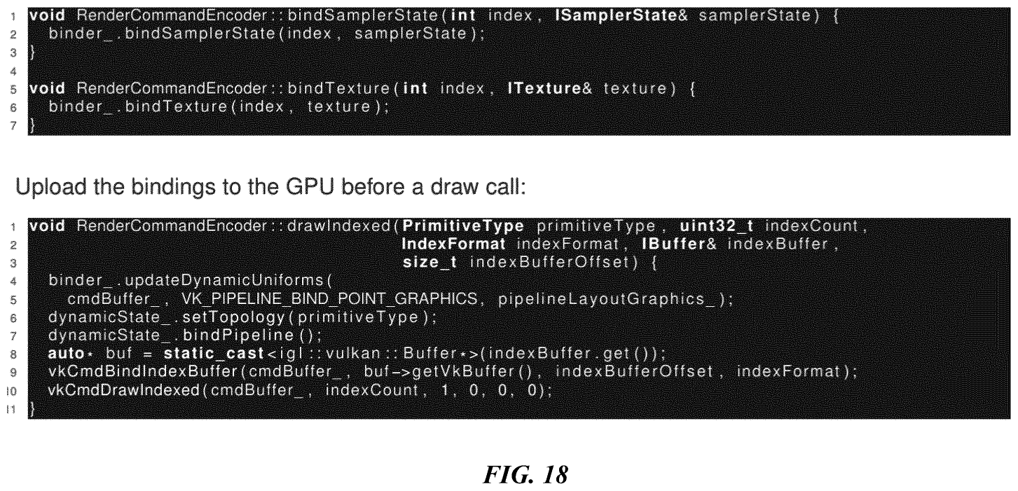

Referring to FIG. 18, the other bind functions in the RenderCommandEncoder (above) simply make a direct call to the binder object. In some embodiments, the RenderCommandEncoder (below) code can perform additional checks such as verifying the validity of the objects and ensuring that the binding slot index meets alignment requirements. Before creating a draw call, we transfer our binding data to the GPU using dynamic uniform buffers. Here once the bidining data for the draw call has been updated, we can execute the actual rule control and commands. This was a brief overview of the role of the render command encoded class.

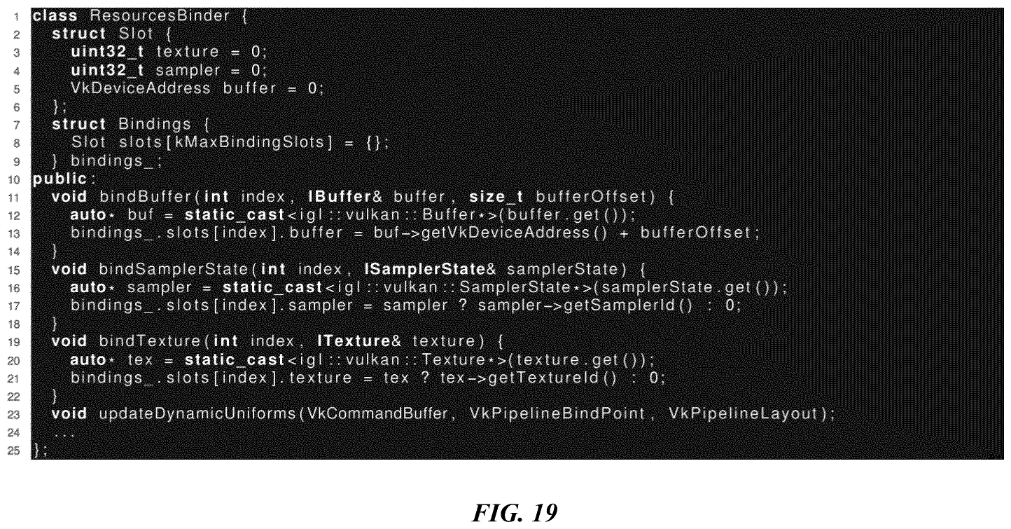

With reference to FIG. 19, now let's take a look at the low level C++ implementation that prepares the data for Vulcan. The ResourcesBinder class is responsible for managing all bindings. Each binding slot is a structure that holds a texture assembler and a buffer. The textures and samplers are stored as integer indices into a large descriptor set that includes arrays for all textures, known as sampled images in Vulcan and all sensors. Buffer accesses using 64-bit addresses. All these binding slots are organized into an array within the binding structure. This structure is transferred to the GPU using dynamic uniform buffers, The binding functions of data array on the CPU side, and the GPU upload occurs prior to a dropout. It is important to note that if you want to make this OpenGL wrapper as simple as possible, you can just use push constants instead of dynamic uniform buffers. However, this would prevent the use of push constants for other purposes and would also limit the possible number of binding slots due to the maximum allow size of push constants, which is just 128 bytes in many Vulcan implementations.

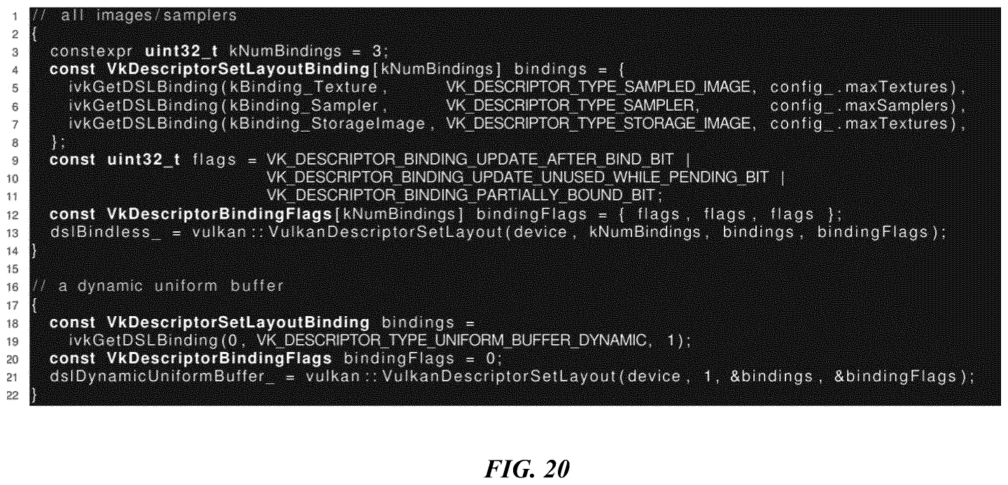

FIG. 20 shows an example where dynamic uniform buffers are used with Vulcan. Let's examine our descriptor set layouts. We only handled two of them in this example, and they are shared by all Vulcan pipelines and shaders in an example system. The first descriptor set layout describes an array of sampled images for all textures, an array of samplers, and a separate array of storage images. We utilize the descriptor indexing features to dynamically update the descriptor sets. This is a standard way of doing so in Vulcan. The second descriptor set layout describes a dynamic uniform buffer. We have a separate layout for it because Vulcan does not allow mixing descriptor reduction and dynamic uniform buffers in one layout.

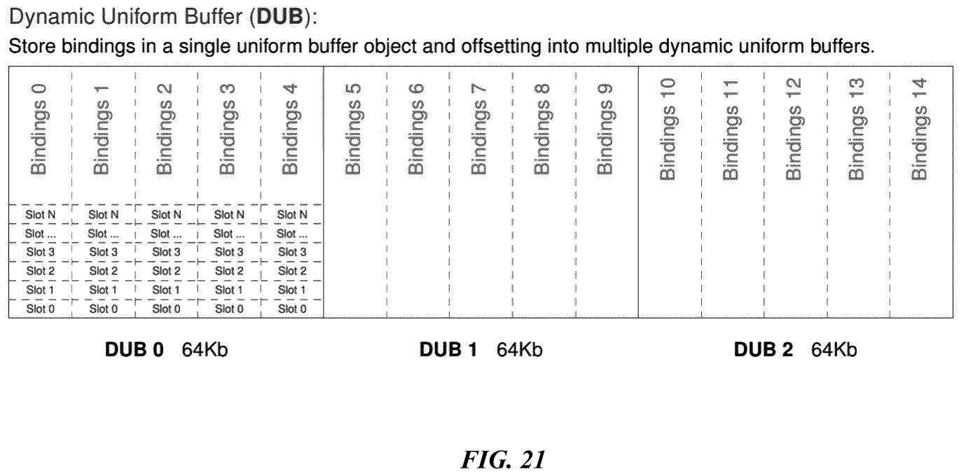

FIG. 21 illustrates how binding data may be organized within dynamic uniform buffers. Dynamic uniform buffers have size limitations on many Vulcan implementations, so we use multiple buffers to fit all our bindings. We choose 64 kilobytes, which is a common size. Our binding structure is 256 bytes allowing us to fit 256 bindings in each dynamic uniform buffer. We write to a dynamic uniform buffer only if a slot in the bindings has changed from the previous draw call. We maintain a separate set of dynamic uniform buffers for each swap chain image, preventing us from overriding data that may still be in use by the GPU, and we don't need any extra GPU to CPU synchronization in this case.

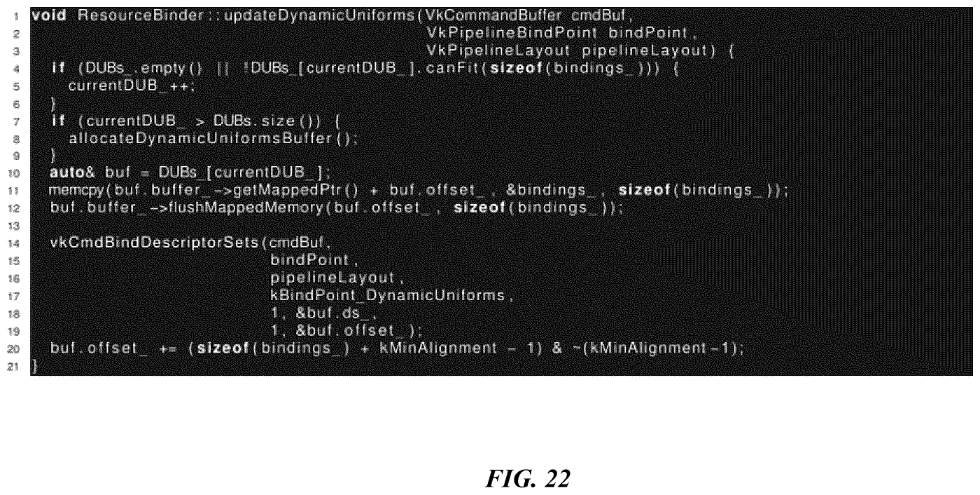

With all our data structures set up, we can now upload the binding of data to the GPU. FIG. 22 shows how, with some sanity checks omitted for simplicity. It only executes if the binding data has changed since the last draw call. We switch to the next dynamic uniform buffer when we run out of space for more bindings in the current buffer. The buffers are allocated in the host visible memory, allowing us to use mem copy to make the data accessible to the GPU. Once the data is copied, we bind the descriptor sets with the current buffer offset, making the desired binding accessible to the shaders. Dynamic uniform buffers have alignment requirements for the offset parameter which we must observe.

Now that we've covered the C++ side, let's examine the shader code and see how it can access our binding data. A library may have two code paths for handling shaders. The first code path may use a language that compile code into SPIR-V, GLSL, metal shading language, or other shading language. This is a useful method as it allows for writing shaders once and then compiling them for every API. A second code path involves taking in backend specific shaders and utilizing the compiler from Chronos to generate SPIR-V code. This is useful for quick prototyping. Let's dive a bit deeper into our GLSL code path. Before sending the shader code to the compiler, we inject the set of data structures and helper functions into the GLSL source code. The GLSL binding structure is essentially a binary representation of the binding structure from C++, and these functions abstract away all the descriptor indexing machinery and allow us to write GLSL code as if we are working with fixed binding slots for textures and sampler. For example, a shader can access a 2d texture in the sampler by calling the textureSample2D function, specifying necessary binding slots, where the binding information from a dynamic uniform buffer and use them for uniform indexing to access the actual texture sampler using the descriptor index. GLSL and SPIR-V allow us to address the arrays of different texture types into the same binding inside one descriptor set. This simplifies the C++ code which updates the descriptor set. The binding code to access buffers can use buffer device addresses directly. We store buffer references as unsigned vectors instead of 64-bit integers because many Vulcan implementations lack support of 64-bit integers inside uniform buffers.

What is claimed is:

1. A method comprising, by an electronic device comprising a phase-modulating display module and an amplitude-modulating display module:
determining a pattern comprising a plurality of zones, wherein the pattern corresponds to display areas that contain imagery content to be displayed, and wherein each zone of the plurality zones corresponds to a plurality of pixels of the amplitude-modulating display module;
steering, by the phase-modulating display module, incident light beams from a first light source to the display areas of the amplitude-modulating display module according to the pattern comprising the plurality of zones;
modulating, by the amplitude-modulating display module, a light intensity amplitude of a light beam at a pixel location according to a target grayscale value for a display pixel at that pixel location; and
causing the light beam having the modulated light intensity amplitude to reach a viewer's eye.
